(19) United States
(12) Patent Application Publication
(10) Pub. No.: US 2022/0405317 A1
(43) Pub. Date: Dec. 22, 2022

(54) Remote Control Device with Environment Mapping

(71) Applicant: Google LLC, Mountain View, CA (US)

(72) Inventors: Richard Lee Marks, Pleasanton, CA (US); Ding Xu, Mountain View, CA (US)

(21) Appl. No.: 17/351,534

(22) Filed: Jun. 18, 2021

(51) Int. Cl. G06F 16/432; G06F 16/435; G06F 16/438; G10L 15/22; G06K 9/00

(52) U.S. Cl. CPC G06F 16/433; G06F 16/434; G06F 16/435; G06F 16/438; G10L 15/22; G06K 9/0063; G10L 2015/223; G10L 2015/228

(57) ABSTRACT

A remote control device for controlling devices in an environment can utilize an environment map and location information to accurately determine an intended device to provide control for multiple devices in an environment. The environment mapping can be performed using the remote control device including a plurality of sensors. A spatial map can be generated for an environment along with location information for controllable devices within the environment. The spatial map and location information can be stored on the remote control device. The mapping can allow the remote control device to quickly group devices or drag and drop content from one type of device to another type of device. The remote control device can perform search queries based on combinations of image and audio data in some examples.

### FIELD

The present disclosure relates generally to remote control devices for controlling multiple devices.

### BACKGROUND

Universal remotes can rely on a large number of buttons or keys to provide the ability to control multiple devices, and switching from controlling one device to controlling another device can be cumbersome. Moreover, universal remotes are often limited to controlling particular types of devices such as televisions and sound systems.

Furthermore, smart outlets, smart lights, and other smart appliances are becoming more prevalent in homes and businesses, but control may be limited to specific control devices associated with a particular appliance, smart phone, tablet, or inputs of the device. Using each individual remote can be burdensome, smart phone or tablet use may not be practical for guests or visitors, and reaching for the inputs on the device essentially defeats the purpose. Moreover, there may be limited inputs.

### SUMMARY

Aspects and advantages of embodiments of the present disclosure will be set forth in part in the following description, or can be learned from the description, or can be learned through practice of the embodiments.

One example aspect of the present disclosure is directed to a handheld remote control device. The handheld remote control device can include a plurality of sensors including one or more inertial sensors, one or more audio sensors, and one or more additional sensors. The handheld remote control device can include one or more processors and one or more non-transitory computer-readable media that collectively store instructions that, when executed by the one or more processors, cause the handheld remote control device to perform operations. The operations can include generating, by at least one of the one or more additional sensors of the handheld remote control device, sensor data descriptive of an environment including a plurality of controllable computing devices. The operations can include generating data representative of a spatial map of the environment based at least in part on the sensor data descriptive of the environment. The operations can include receiving one or more inputs from a user of the handheld remote control device in association with each of the plurality of controllable computing devices. In some implementations, the operations can include generating, by the one or more inertial sensors, inertial data indicative of an orientation of the handheld remote control device. In response to the one or more inputs associated with each controllable computing device of the plurality of controllable computing devices, the operations can include identifying a location of such controllable computing device based at least in part on the spatial map and the inertial data associated with one or more time periods associated with the one or more inputs. The operations can include generating location information for the spatial map indicating the location within the environment of each controllable computing device of the plurality of controllable computing devices. The operations can include storing the data representative of the spatial map and the location information locally by the handheld remote control device. In some implementations, the operations can include receiving first audio data with the one or more audio sensors at a first time when the user is pointing the handheld remote control device toward a first controllable computing device of the plurality of controllable computing devices. The first audio data can include first speech data from the user. The operations can include processing the first audio data to determine a first command applicable to said first controllable computing device of the plurality of controllable computing devices and causing the first command to be carried out by said first controllable computing device of the plurality of controllable computing devices. The operations can include receiving second audio data with the audio sensor at a second time when the user is pointing the handheld remote control device toward an object that is not one of the controllable computing devices. The second audio data can include second speech data from the user. The operations can include processing the second audio data to determine a second command. In some implementations, the second command can include a context-based voice-triggered search function. The operations can include processing image data from the one or more image sensors to determine one or more semantic attributes associated with the object. The operations can include generating one or more textual search queries based on the context-based voice-triggered search function and the one or more semantic attributes associated with the object. The operations can include generating one or more outputs at the handheld remote control device based on search results received in response to the one or more textual search queries.

Another example aspect of the present disclosure is directed to a computer-implemented method for device grouping. The method can include generating, by an inertial measurement sensor of a remote control device, movement data indicative of movement of the handheld remote control device. The method can include generating, by one or more image sensors of the remote control device, image data descriptive of an environment including a plurality of controllable devices. The method can include detecting, by one or more processors of the remote control device and based at least in part on the movement data, that a user of the remote control device has performed a grouping gesture. The method can include accessing, by the one or more processors, data representative of a spatial map including three-dimensional coordinate information of the environment including location information for the plurality of controllable devices. The method can include identifying, by the one or more processors, at least a first controllable device and a second controllable device associated with the grouping gesture based at least in part on the movement data, the image data, and the spatial map. In some implementations, the method can include generating, by the one or more processors, a device grouping for the first controllable device and the second controllable device and storing, by the one or more processors, the device grouping locally on the remote control device.

Another example aspect of the present disclosure is directed to an interactive object. The interactive object can include a plurality of sensors including an audio sensor, an image sensor, and an inertial measurement sensor. The interactive object can include one or more processors and one or more non-transitory computer-readable media that collectively store instructions that, when executed by the one or more processors, cause the interactive object to perform operations. The operations can include determining, based on inertial data from the inertial measurement sensor, an orientation of the interactive object within an environment including a plurality of network-controllable devices. The operations can include accessing data representative of a spatial map including three-dimensional coordinate information of the environment including the plurality of network-controllable devices. The operations can include processing image data from the image sensor to determine a position of the interactive object within the environment based at least in part on the orientation of the interactive object. In some implementations, the operations can include identifying a selected network-controllable device based at least in part on the position of the interactive object and the spatial map. The operations can include obtaining, from the audio sensor, audio data descriptive of speech of a user and determining a selected device action for the selected network-controllable device based at least in part on the audio data.

Another example aspect of the present disclosure is directed to a handheld remote control device. The handheld remote control device can include a plurality of sensors including one or more inertial sensors and one or more additional sensors. The handheld remote control device can include one or more processors and one or more non-transitory computer-readable media that collectively store instructions that, when executed by the one or more processors, cause the handheld remote control device to perform operations. The operations can include generating, by at least one of the one or more additional sensors of the handheld remote control device, sensor data descriptive of an environment including a plurality of controllable computing devices. The operations can include generating data representative of a spatial map of the environment based at least in part on the sensor data descriptive of the environment. The operations can include receiving one or more inputs from a user of the handheld remote control device in association with each of the plurality of controllable computing devices. The operations can include generating, by the one or more inertial sensors, inertial data indicative of an orientation of the handheld remote control device. In response to the one or more inputs associated with each controllable computing device of the plurality of controllable computing devices, the operations can include identifying a location of such controllable computing device based at least in part on the spatial map and the inertial data associated with one or more time periods associated with the one or more inputs. In some implementations, the operations can include generating location information for the spatial map indicating the location within the environment of each controllable computing device of the plurality of controllable computing devices. The operations can include storing the data representative of the spatial map and the location information locally by the handheld remote control device.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing environment including a remote control device according to example embodiments of the present disclosure.

FIG. 2 depicts a block diagram of an example computing environment including a remote control device and various controllable devices within a living space according to example embodiments of the present disclosure.

FIG. 3 depicts a block diagram of a computing system including a remote control device and a process for identifying and controlling a selected controllable device according to example embodiments of the present disclosure.

FIG. 4 depicts a block diagram of a remote control device including an example user interface state machine according to example embodiments of the present disclosure.

FIG. 5A is a schematic diagram depicting a perspective view of an example handheld remote control device according to example embodiments of the present disclosure.

FIG. 5B is a schematic diagram depicting a perspective view of an example handheld remote control device according to example embodiments of the present disclosure.

FIG. 6A depicts a schematic diagram of an example handheld remote control device according to example embodiments of the present disclosure.

FIG. 6B depicts a schematic diagram of an example handheld remote control device according to example embodiments of the present disclosure.

FIG. 6C depicts a schematic diagram of an example handheld remote control device according to example embodiments of the present disclosure.

FIG. 7 depicts an illustration of an example handheld remote control device according to example embodiments of the present disclosure.

FIG. 8 depicts a flow chart diagram of an example method to generate and store a spatial map of an environment including a plurality of controllable devices according to example embodiments of the present disclosure.

FIG. 9 depicts a flow chart diagram of an example method of grouping multiple controllable devices by a remote control device according to example embodiments of the present disclosure.

FIG. 10 depicts a flow chart diagram of an example method of processing audio data in accordance with a spatial map to process a search query according to example embodiments of the present disclosure.

FIG. 11 depicts a flow chart diagram of an example method of controlling a second controllable device based on sensor data generated based on a first controllable device according to example embodiments of the present disclosure.

FIG. 12 depicts a flow chart diagram of an example method of controlling a remote control device according to example embodiments of the present disclosure.

FIG. 13 depicts a flow chart diagram of an example method of processing audio data in accordance with a spatial map to process a speech command according to example embodiments of the present disclosure.

FIG. 14A depicts an illustration of an example gesture according to example embodiments of the present disclosure.

FIG. 14B depicts an illustration of an example gesture according to example embodiments of the present disclosure.

FIG. 14C depicts an illustration of an example gesture according to example embodiments of the present disclosure.

FIG. 15 depicts an illustration of an example remote control device use according to example embodiments of the present disclosure.

FIG. 16 depicts an illustration of an example remote control device use according to example embodiments of the present disclosure.

FIG. 17 depicts an illustration of an example remote control device use according to example embodiments of the present disclosure.

FIG. 18 depicts an illustration of an example remote control device use according to example embodiments of the present disclosure.

FIG. 19 depicts an illustration of an example remote control device use according to example embodiments of the present disclosure.

FIG. 20 depicts an illustration of an example remote control device use according to example embodiments of the present disclosure.

FIG. 21 depicts an illustration of an example remote control device use according to example embodiments of the present disclosure.

FIG. 22 depicts an illustration of an example remote control device use according to example embodiments of the present disclosure.

FIG. 23A depicts a block diagram of an example computing system that performs environment mapping and remote control device configuration according to example embodiments of the present disclosure.

FIG. 23B depicts a block diagram of an example computing device that performs environment mapping and remote control device configuration according to example embodiments of the present disclosure.

FIG. 23C depicts a block diagram of an example computing device that performs environment mapping and remote control device configuration according to example embodiments of the present disclosure.

FIG. 24A depicts a block diagram of a simplified example artificial intelligence system according to example embodiments of the present disclosure.

FIG. 24B depicts a block diagram of a simplified example artificial intelligence system according to example embodiments of the present disclosure.

FIG. 24C depicts a block diagram of a simplified example artificial intelligence system according to example embodiments of the present disclosure.

FIG. 25 depicts a block diagram of an example visual search system including a query processing system according to example embodiments of the present disclosure.

FIG. 26 depicts a block diagram of an example visual search system including a query processing system and ranking system according to example embodiments of the present disclosure.

FIG. 27 depicts a block diagram of an example visual search system and context component according to example embodiments of the present disclosure.

Reference numerals that are repeated across plural figures are intended to identify the same features in various implementations.

### DETAILED DESCRIPTION

Generally, the present disclosure relates to remote control devices such as handheld and/or wearable remote control devices configured with sensors that enable the device to generate, store, and access a spatial map for controlling a variety of network-controllable devices such as speakers, displays (e.g., televisions, etc.), electrical outlets, light bulbs, and other so-called smart devices capable of control over a network and/or direct connection. For example, a handheld or wearable remote control device can include various types of sensors such as image capture devices, inertial measurement units, ultra-wideband sensors, microphones, etc. that enable the remote control device to generate a spatial map that describes an environment and the location of network-controllable devices within the environment, as well as to identify device(s) that a user intends to control. For example, the spatial map may include three-dimensional coordinates describing an environment and the location of network-controllable objects within the environment. The remote control device can identify a device selected by the user based on an orientation of the remote control device and the spatial map. For instance, the remote control device can access inertial data from an inertial measurement unit to determine the orientation of the remote control device, access the spatial map to determine a location of the remote control device within the environment based on image data or ultra-wide band (UWB) data, and identify a controllable device pointed to by the remote control based on the orientation and location.

A remote control device in accordance with example embodiments provides universal and communal control device for multiple controllable devices in one or more environments. A user can freely interact with a variety of devices encountered in daily life using a single device with intuitive functions that can be leveraged simply by pointing the remote control at a device the user intends to control. The remote control device can utilize one or more locally stored spatial maps and location information to accurately determine which controllable device the user intends to manipulate and how the user intends to manipulate that controllable device.

A remote control device in accordance with example aspects of the present disclosure generates and locally stores a spatial map of an environment based on sensor data generated by the remote control device. The remote control device can map an environment using sensor data generated by one or more image sensors, ultra-wide band sensors, and/or radar sensors and the like. The remote control device can use the sensor data and one or more inputs provided by a user to determine a location of a plurality of controllable devices in the environment. The location information and the spatial map can enable the use of the handheld remote control device to manipulate controllable devices in the environment. Manipulating or controlling the devices can include, but is not limited to, grouping the controllable devices, dragging and dropping content from one device to another device, and general remote control manipulation of the devices (e.g., turning on a device, changing the volume of a device with audio output, etc.).

According to an example aspect, a remote control device can include a plurality of sensors including one or more image sensors, ultra-wideband sensors, and/or one or more inertial sensors. The sensors can be used for generating a spatial map of an environment. The sensors can generate sensor data that is descriptive of the environment and the plurality of controllable computing devices in the environment. The sensor data can be used to generate a spatial map including a spatially-aware representation of the environment. After generating the spatial map, the remote control device can receive one or more inputs from a user. The one or more inputs can be associated with one of the plurality of controllable computing devices in the environment. Inertial data can be generated using the one or more inertial sensors. The location of each of the plurality of controllable computing devices can be identified using the spatial map and the position/orientation of the remote control device as may be determined using image data, UWB data, and/or inertial data, in response to the one or more inputs. The locations can then be used to generate location information for the spatial map, in which the location information indicates the location of each controllable computing device in the environment. The spatial map including the location information can then be stored locally in the handheld remote control device.

Traditional remote control devices provide a variety of hurdles that can hinder the user experience. Traditional control devices often require several inputs before the remote can be used for a selected device. For example, a traditional remote may require a user to provide an input to select a particular device then provide another input to select a particular function for the device. Moreover, controllable device pairing and unpairing may be complicated and tedious. Traditional remotes often include a large number of buttons or keys in which only a small portion of the buttons or keys are usable at one time. Traditional remotes can also fail to provide a user with feedback or input displays. Moreover, traditional remotes often only receive input via the buttons and keys on the remote.

A remote control device in accordance with example aspects of the present disclosure provides an improved user experience by leveraging environment mapping to accurately determine an intended controllable computing device. A handheld or wearable remote control device can utilize a spatial map, one or more inertial sensors, and one or more additional sensors such as image sensors or UWB sensors to quickly and seamlessly determine which controllable device a user intends to control. Moreover, in some implementations, the remote control device can utilize a display screen to provide user options, user notifications, and other information to allow for more intuitive and informed use. The remote control device can also provide haptic feedback or an audio notification to inform the user of successful or unsuccessful actions. The remote control device disclosed herein can also provide the ability to control controllable devices using voice commands, gestures, or via dragging and dropping content. The quick and seamless transition from controlling one device to controlling a different device, the added notifications and display, and the different input options can improve the user experience.

Generating a spatial map for use by the remote control device can include obtaining sensor data from a plurality of sensors. The sensor data can be processed to determine depth information for the environment, and the depth information can be processed to generate a dimensionally-aware spatial map of the environment. Device locations for each controllable device in the environment can be added to the spatial map based on one or more user inputs, inertial data, and environmental sensor data such as image data or UWB data. The remote control device can receive one or more inputs from a user indicating that the remote control device is currently pointing to or is proximate to one of the controllable computing devices. The inertial sensors can generate inertial data, which can be processed to determine a remote control device orientation Additionally and/or alternatively, the remote control device can determine the device orientation using UWB data and/or image data. Using the remote control device orientation and environmental data such as can be determined from image data or UWB data, the remote control device can identify its location within the environment. Based on the remote control device orientation and location, the remote control device uses the spatial map to determine a location of the controllable computing device. The remote control device can generate location information for the controllable device based on the remote control device orientation and location to map an associated location in the spatial map of the controllable device the remote control is pointing to. The location information can be stored in the spatial map, and the process can be repeated for each controllable computing device in the environment. The spatial map with location information can then be stored locally on the handheld remote control device.

The generated spatial map can be used to determine what device a user intends to control. For example, in some implementations, the handheld remote control device can receive one or more inputs. The inputs can be inputs intended to control a controllable device in the environment. In response to the one or more inputs, the inertial sensors of the handheld remote control device can generate inertial data descriptive of a handheld remote control device orientation. The generated inertial data and the stored spatial map can then be used to determine the intended controllable device by determining which device the handheld remote control device is pointed at or near.

In some implementations, one or more image sensors can be used to generate the spatial map. More specifically, the image sensors can be used to generate one or more images of the environment. The images can be of different portions of the environment and may be captured from different perspectives. The images can be processed to determine depth information for the environment. The depth information can be determined by analyzing proportional changes in portions of the environment including proportion changes of objects in the environment. In some implementations, the determination process may utilize image segmentation, image recognition, or other image processing techniques to determine the depth information. The depth information can then be used to generate a spatial map, which can include a three-dimensional, spatially-aware representation of the environment.

Additionally and/or alternatively, ultra-wideband technology can be used to determine controllable device locations. A plurality of ultra-wideband transceivers can be used to determine a location for each controllable device in the environment. The ultra-wideband transceivers can be included in the handheld remote control device and throughout the environment. Therefore, in some implementations, the handheld remote control device can generate UWB data based on communication information transmitted and received via the ultra-wideband transceiver. The UWB data can be descriptive of a distance between a handheld remote control device and each of the plurality of controllable devices. In some implementations, the handheld remote control device can include one or more UWB antenna systems disposed on the remote side of a handheld remote control device that is integrated to serve as the transmitter, and in the environment, a three antenna receiver can receive the signal from the transmitter to calculate the spatial location of the handheld remote control device. Other UWB configurations may be used.

In some implementations, the UWB data and generated inertial data can be processed to generate a spatially-aware controllable device map. For example, the handheld remote control device can register the location of each controllable device in the environment by receiving one or more inputs respective to a certain controllable device. In response to the one or more inputs, the handheld remote control device can generate inertial data with the one or more inertial sensors. The handheld remote control device can process the inertial data to determine a handheld remote control device orientation. The handheld remote control device can then obtain UWB data descriptive of a distance. The UWB data descriptive of distance can be obtained in a variety of ways. One example can include determining a location of the handheld remote control device when proximate a target controllable device (e.g., a prompt can be provided instructing a user to position the remote control device proximate a controllable device).The three-dimensional location data generated by the UWB sensor can be used to determine the device location which can be stored in or otherwise in association with the map. Another example can include capturing the remote control device location from two or more different perspectives relative to a controllable device. The system can determine UWB data when the remote control device is positioned at two or more locations relative to the target controllable device. The device orientation can be determined at each location. For example, the device can draw or otherwise determine a line at each perspective using the remote control device's location and orientation. An intersection of the lines passing from the control device to the target controllable device at each location can be determined as the targeted controllable device location. Another example can include assuming there is a bounding box for the room and using the three-dimensional location of the UWB together with the IMU data to determine a line to the bounding box. A point that intersects with the bounding box can be determined to be the device location. The UWB data and the orientation can be processed to determine a location data set for the controllable device. The process can be repeated for each controllable device. The location data sets can then be used to generate a spatially-aware controllable device map that can be descriptive of relative locations of each controllable device in the environment.

Moreover, in some implementations, the inertial data for generating the controllable device map can be replaced with additional UWB data by using one or more additional ultra-wideband devices with the handheld remote control device. The additional ultra-wideband devices can be used to triangulate the controllable device based on the data from the remote control device and each additional ultra-wideband device (e.g., an additional ultra-wideband device may be put in one or more corners of the environment). The one or more additional ultra-wideband devices can be devices with manually entered locations or pre-determined locations. In some implementations, the additional ultra-wideband devices may be other controllable devices in the environment.

In some implementations, the remote control device can generate a locally stored spatial map based at least in part on obtaining UWB data in response to an input. The UWB data and the inertial data can then be used to determine the intended controllable device.

In some implementations, the remote control device can include an ultra-wideband transceiver on each end of the handheld remote control device. The two ultra-wideband transceivers can be used to obtain UWB data for each end of the handheld remote control device, which can then be used to determine the orientation of the remote. The two ultra-wideband receiver handheld remote control device can use the UWB data from each transceiver to determine a distance between a controllable device and each end of the remote control device. The distances can then be compared to determine if the remote control device is pointing at that particular controllable device. In some implementations, the controllable device with the greatest change in distance between the two remote control device transceivers can be determined to be the intended device. The determination process may further include determining that a front remote control device transceiver is the closer of the two remote control device transceivers.

In some implementations, LiDAR can be used to determine the depth information of the environment. The resulting depth information can be processed to generate a spatial map, which may include three-dimensional point cloud data.

Mapping an environment with a remote control device can enable the device to better understand the environment, which device a user wants to control, and how the user wants to control that device. Additionally and/or alternatively, mapping can enable the environment system to understand the user's presence in a certain room/space and/or the proximity of devices in the space to provide a tailored experience. In some examples, one or more image sensors can be used to map the environment by capturing images of the environment with the handheld remote control device. The images can cover overlapping portions of the environment such that parts of the environment including certain objects in the environment may be captured in multiple images. The images can be processed to determine depth information for the environment. Processing the images can involve detecting changes in size or distortions in the environment or changes in object size or proportions between images. Alternatively and/or additionally, processing the images can involve synthesizing the plurality of images to generate a media file containing the data of all of the images. The depth information for the environment can then be used to generate a spatial map. In some implementations, the spatial map can be generated by using the depth information to generate a schematic view of the environment using a plurality of layers to create a three-dimensional understanding of the environment. The depth information and/or the spatial map may include point cloud data to represent the relative depths of each portion or object in the environment.

The remote control device environment mapping may also include controllable device mapping. Collecting location information can involve retrieving input data and motion data from the handheld remote control device. The motion data can be generated by inertial sensors and the input data can be generated from processing button selections, audio data from a microphone, image data, and/or a touch selection on a touchscreen component of the remote control device. In some implementations, the input data may trigger the generation of the motion data, and the motion data can be used to generate location information for a respective controllable device. The process can be repeated until location information is generated for each controllable device in the environment. The spatial map and the location information may be stored locally in the remote control device. In some implementations, the spatial map and the location information may be used to generate a network map in which each controllable device is mapped in the spatial map.

For example, the determination of controllable device locations can include receiving one or more inputs. The inputs can be received and processed by the remote control device, and in response to the inputs, the inertial sensors can generate inertial data and the additional sensors such as image sensors and/or UWB sensors generate UWB data. The inertial data and additional sensor data can then be processed to determine the remote control device orientation and may be processed with the spatial map to determine a controllable device location. The location, the input data, and the spatial map can be processed to generate location information to be included with the spatial map which can include a device name and location. The process can be completed for each controllable device in the environment.

Once the environment is mapped and the device location is determined, the handheld controllable device can leverage the information to control the controllable devices. The mapping can allow the system to understand the location and orientation of the handheld remote control device, which can be used to determine what controllable device to manipulate. Controlling the devices can include basic remote tasks, such as turning a device on, or can include more processing intensive tasks, such as grouping devices or controlling one device based on the content of another device.

In some implementations, mapping of an environment can include generating image data descriptive of an environment. The image data can be generated with one or more image sensors included in the remote control device. The image sensors can be cameras, and the image data can include or be based on one or a plurality of images taken of the environment. Moreover, the generation of the images may be triggered by a user input, which can include a button selection, a voice command, a selection on a touchscreen, or another input. Alternatively and/or additionally, the generation of image data may be prompted by the remote control device being in an environment, detecting movement, etc. In some implementations, light detection and ranging (LiDAR) data may be collected to complement or replace the image data. The LiDAR data may be generated by emitting a laser in the remote control device and obtaining the time the laser takes to return to the device.

The generated image data can be processed to determine depth information for the environment. The processing can be completed by processors included in the handheld remote control device or may be completed by a separate computing device. The determined depth information can be descriptive of different depths for different portions of the environment or different depths of objects in the environment. In some implementations, processing the image data to determine depth information can include image recognition processing. Image recognition processing can be completed locally or on a separate computing device. Processing the image data to determine depth information can include image segmentation. In some implementations, LiDAR data may be obtained and processed to determine the depth information. Alternatively and/or additionally, inertial data may be obtained and processed to aid in determining the depth information.

The depth information can be used to generate a spatial map of the environment. The spatial map can include three-dimensional point cloud data. The spatial map can be a dimensionally aware representation of the environment. In some implementations, the spatial map can be descriptive of a three-dimensional representation of the environment. The spatial map may include a three-dimensional model of the environment generated based on the depth information. Depth, height, and angles of the environment may be determined by processing the depth information, a plurality of images from an environment walkthrough, and inertial data to provide a realistic spatial modeling map of the environment.

In some implementations, the systems and methods for environment mapping can include receiving one or more inputs from a user of the remote control device in association with each of the plurality of controllable computing devices. The inputs can be button selections, voice commands, and/or touch selections on a touchscreen. In some implementations, the input can include the image sensor receiving image data that includes one or more features that are processed by the one or more processors and are determined to include recognizable data. The recognizable data can be character data that can be recognized using recognition techniques (e.g., optical character recognition (OCR)). For example, the characters can be a yin number of a controllable device. In some implementations, the recognizable data can be a QR code for scanning. Alternatively and/or additionally, the remote control device may obtain network data descriptive of controllable devices on the network. The network data can aid in identifying the one or more controllable devices.

Moreover, the systems and methods can obtain or generate inertial data indicative of an orientation of the handheld remote control device using one or more inertial sensors. The one or more inertial sensors can be housed in the handheld remote control device, and the sensors may record data indicative of six degrees of freedom. The inertial data may be used to determine an orientation of the remote control device and may also be used to determine a planar location of the remote control device. In some implementations, image data and inertial data may be obtained or generated simultaneously. Moreover, in some implementations, the orientation can be determined by one or more of image data, inertial data, and/or UWB data.

The remote control device may use the inertial data and the depth information to identify a location of a controllable device in response to the user input. Identifying the location may involve using the elapsed time period for collecting the inertial data to provide context for the motion recorded. The identification process may occur for each controllable device in the environment. In some implementations, the location may be identified using ultra-wideband communication or another form of wireless communication between the handheld remote control device and controllable devices in the environment.

Location information can then be generated for each controllable device. The location information can indicate the location within the environment of each controllable computing device. In some implementations, the location information can be added to the spatial map. In some implementations, the location information of each controllable device may be used to generate zones for each controllable device in the environment, such that if a user points the handheld remote control device towards the zone, the remote control device may interpret a manipulation input as being intended for that specific device. In some examples, the remote control device may provide haptic feedback in response to detecting that the remote control device is pointed toward a zone or a network-controllable device within a zone.

In some implementations, the remote control may have an audio sensor. The audio sensor can obtain audio data. The audio data can include speech data descriptive of a device label. In some implementations, the audio data can be processed along with the inertial data to generate a label for each of the controllable computing devices. The process can be repeated for each controllable computing device. The one or more labels, the location information, and the spatial map can then be used to generate a labeled spatial map, in which each controllable computing device is denoted with a respective label. In some implementations, the audio data descriptive of a device label can be coupled with a location as part of generating a spatial map with labels.

The spatial map and the location information can be stored locally on the handheld remote control device. Alternatively and/or additionally, the spatial map and the location information may be stored on a server computing device or in the cloud. In some implementations, the labeled spatial map may be stored locally on the handheld remote control device.

In some implementations, the environment mapping process may be pre-empted, followed by, or occur simultaneously with obtaining network data. The network data can include data descriptive of the one or more controllable devices connected to a network. The one or more controllable computing devices may be within the environment and may be configured or registered with the network such that each controllable device can be manipulated by a handheld remote control device. The configuration or registration of the controllable devices can be completed on the handheld remote control device, a mobile phone, a computer, the device itself, or any other computing device.

The remote control device can include a variety of features and components. For example, the handheld remote control device may include a wireless adaptor for wireless communication over a network, such that the handheld remote control device can leverage WiFi to communicate with the controllable devices. Alternatively and/or additionally, the handheld remote control device may include a Bluetooth receiver to enable a Bluetooth connection between the remote control devices and one or more controllable devices. In some implementations, the remote control device may include an ultra-wideband wireless transceiver. The ultra-wideband wireless transceiver may be used to generate location information for each controllable device in an environment. In some implementations, the UWB system may also be used to communicate with the controllable devices.

Further components of the remote control device can be utilized to provide a user with feedback to enhance the user experience. For example, in some implementations, the remote control device can include an electronic display, one or more buttons on a first side of the remote control device, and/or one or more buttons on a second side of the remote control device. The electronic display can be a touchscreen and can display optional controls for the one or more controllable devices or can relay information obtained from the controllable devices in the environment. The buttons can be used to receive user input, and the buttons can be configured in a variety of configurations and may include a variety of button types (e.g., push buttons, triggers, d-pads, touchpads, etc.). Furthermore, in some implementations, the remote control device can include one or more haptic devices (e.g., including vibrational components) configured to provide haptic feedback. Haptic feedback may be used to notify a user of a failed input, connection of a new controllable device, the completion of an action, and/or general input feedback.

For example, haptic feedback can be provided in response the remote control device changing direction from the pointing zone of a first controllable device to the pointing zone of a second controllable device or vice versa. The pointing zones can be zones generated and mapped in the spatial map. In some implementations, silent haptic feedback can be provided in response to the remote control device entering the pointing zone of a mapped controllable device. The haptic feedback response can aid in the use of the remote control device by allowing the user to feel a demarcation between the controllable devices. Moreover, the haptic feedback can make it easy to pick one over the other with low effort.

A configured remote control device can be programmed for a variety of uses, including, but not limited to, device grouping, drag and drop, voice-triggered search, point and speak voice control, and general controllable device manipulation.

The remote control device can perform device grouping by intaking and processing a gesture input to group two or more controllable devices. The remote control device can obtain motion data from an inertial sensor.

The motion data can be processed to determine a gesture. The gesture can include a gesture to group a plurality of devices. In some implementations, the gesture may be a lasso gesture, in which the gesture encompasses a first device and a second device. Alternatively and/or additionally, the gesture may include a click and drag gesture, in which the remote control device receives a continuous input to select two or more controllable devices. The drag motion can create a shape around multiple devices intended to be grouped or can include pointing at each device intended to be grouped.

The gesture can be processed to determine that the gesture selects a first device and a second device for grouping. In some implementations, the gesture can select three or more controllable devices for grouping. Moreover, the gesture can be determined to select a pre-existing device group and a new controllable device to add the pre-existing grouping and the new device to a new group. In some implementations, the gesture can be used to group two or more pre-existing groups for a new grouping.

The remote control device can generate a device grouping for the first device and the second device, based on the received gesture and determined selections. In some implementations, the device grouping can include three or more controllable devices. The remote control device can receive a user input to label the device grouping. For example, audio data descriptive of speech data can be obtained and processed to determine a command related to the labeling of the device grouping. In response to determining the command, the remote control device can generate a label for the device grouping. The device grouping can be stored locally on a handheld remote control device and/or a server computing system. The device grouping labels can also be stored locally on the remote control device.

The device grouping can be used to control each device in the grouping as a collective whole. For example, the system can obtain a user input to control the device grouping. An intended action can be determined based on the user input. The remote control device can send instructions to the devices in the device grouping to complete the intended action. In some implementations, the intended action can include turning on all devices in the device grouping. Alternatively and/or additionally, the instructions can include a command to turn on the first device and the second device.

In some implementations, the user input for device grouping can involve the compression of one or more buttons of the handheld remote control device, a motion to make a lasso gesture around a plurality of controllable devices and a release of the one or more buttons after the lasso gesture is completed. Alternatively, the user input can involve individually pointing at each device intended to be grouped. Additionally and/or alternatively audio input can be used for device grouping.

Systems and methods for drag and drop can allow a user the ability to control the content of a controllable device based on other devices or objects in the environment. For example, a color changing light bulb can change its color to orange in response to a user capturing an image of an orange object and dragging to the location of the light bulb. Drag and drop can involve holding a button while a handheld remote control device is moved by a user, similar to a drag and drop input with a computer mouse. For example, a user can compress a button while pointed at a first controllable device and not release the button until pointed at a second controllable device, which can cause the second controllable device to be controlled based at least in part on data related to the first controllable device.

According to example aspects, the remote control device receive a first input from which a first device selection can be determined based on the first input and one or more sensors housed in the handheld remote control device (e.g., one or more inertial sensors, one or more image sensors, etc.). In response to the determination of a first device selection, the remote control device can obtain a first device data set from a first device. The first device can be a controllable device in the environment or an object. The first device dataset can be image data generated by an image sensor, media data collected via a wireless connection, and/or audio data generated by an audio sensor. The control device can then obtain a second input. A second device selection can be determined based on the second input and one or more sensors. The second device can be a controllable device in the environment (e.g., a television, a speaker system, a light fixture, etc.). Based on the first device data set and the second device selection, a second device action can be generated. The control device can then send, by a wireless communication component, instructions to a second device based on the second device action. In some examples, the instructions may be sent to another device such as a network control device that in turns sends to the second device the instructions or instructions derived therefrom.

The remote control device can determine and generate a second device action by processing the first device data set to generate a semantic understanding of the first device data set. For example, the first device data set can include one or more images of an object. The second device selection can be a color changing light bulb fixture. Based on the second device selection, the system can determine that an intended action is a color changing action, and in response to the determination, the system can extract a color from the one or more images in the first device data set. The color extraction can include determining a color average, a median color, a modal color, and/or a color theme. In some implementations, the color extraction process can include removing outliers from the data set and/or image segmentation to isolate an intended object or device. Based on the intended action and the extracted color, the systems can generate a second device action that includes a command to change the light bulb to the one or more extracted colors.

In some implementations, the remote control device can drag and drop content between devices by processing the first device data set of a first media data type and generating a second device action including playing a second media data type. For example, the first device data set can include image data or video data, and the determined second action can be to play audio data based on the second device selection being a speaker system. More particularly, the handheld remote control device may obtain images of an album or CD cover to generate a first device data set. The second device selection can include a sound system or speaker system. The handheld remote control device can either process the first device data set locally or utilize a server computing system to determine the contents of the one or more images, to recognize the album or CD cover, and in turn, determine a second device action that includes playing music or audio media associated with that album or performer. Another example can involve obtaining audio data to generate a first device data set and generating a second device action that can include playing a video content item. For example, the first device data set can include audio data obtained with one or more audio sensors. The audio data can be processed to determine that the audio data is descriptive of a portion of a motion picture soundtrack. The system can determine that the second device selection is a video media player (e.g., a smart television, a video dongle, a laptop, etc.). The system can then generate a second device action that includes playing the motion picture the motion picture soundtrack comes from.

The remote control device can process and understand the media data type and content of the first device data set, determine an intended action based on the second device selection, and generate a second device action that can be completed by the second device that is associated to or related to the first device data set.

In some implementations, the first input can be the beginning of a button or touchscreen compression, and the second input can be the end of the compression. Alternatively and/or additionally, the first input and the second input can be separate compressions. The first input and second input can include voice commands, visual triggers, and/or any other form of input. In some implementations, the first input can be a touch input, and the second input may be an audio input or vice versa. In some implementations, the first input may be a copy input and the second input may be a paste input.

A handheld interactive object, or handheld remote control device, can be utilized to generate search queries and receive search results. For example, a handheld interactive object can be programmed to enable voice-triggered search functionality.

For example, voice-triggered searching can include obtaining audio data with an audio sensor. The audio data can include speech data descriptive of a command. The audio data can be processed to determine the command. The command can include a context-based voice-triggered search function. Processing the audio data to determine the command can include processing the audio data with an analog-to-digital converter for analog-to-digital conversion. In some implementations, processing the audio data to determine a command may include using a natural language processing model for natural language processing.

The determination for the command can trigger the generation of image data by obtaining the image data with one or more image sensors (e.g., a camera). The image data and the audio data can be processed to determine a search query. In some implementations, the search query can include one or more search terms and one or more images.

The search query can then be input into a search engine. In response, the systems and methods can receive one or more search results based on the search query. One or more of the search results can be provided. In some implementations, the one or more search results may be provided on a visual display of a handheld interactive object. Alternatively and/or additionally, one or more of the search results can be provided via an audio notification. The audio notification can be output by one or more speakers of a handheld interactive object.

The voice-triggered search function can be used to retrieve information on a consumer product. The command can be a command to search information on an object (e.g., a consumer product). One or more images on the consumer product can be obtained to generate a consumer product search query, and in response, the one or more search results can be information on the consumer product. More particularly, the voice command can include “how many calories is in this?” The object in front of the handheld interactive object can be a container of soda. The search query can include images of the container and the search terms can include “how” AND “many” AND “calories.” The resulting search results can include the calories of that soda according to the size of the container and/or according to the serving size. The calorie count can then be output as an audio notification or can be output on the visual display.

In some implementations, the search query can include natural language syntax and/or Boolean syntax and terms.

Controllable devices in the environment can be manipulated using voice commands. For example, a handheld remote control device can obtain audio data descriptive of a command with an audio sensor (e.g., a microphone). One or more processors can process the audio data to determine a command descriptive of one or more manipulation actions for a controllable device. The handheld remote control device can determine the manipulation action and instruct the controllable device to complete the desired action. In some implementations, the handheld remote control device may determine the intended controllable device based on the device being pointed at. The point and speak voice control may be initiated by a button selection or touchscreen selection.

Manipulation actions can include a variety of different actions. Manipulation actions can include turning a device on or off, changing the volume of a controllable device, changing the settings of a controllable device, changing the light intensity of a device, and/or content item selection (e.g., channel selection, application selection, CD selection, movie title selection in a streaming application, etc.).

In some implementations, the handheld remote control device can be utilized to control each controllable device in an environment with button selections, touchscreen selections or swipes, and/or motion gestures.

In some implementations, the systems and methods disclosed herein can be implemented into an augmented-reality experience or a virtual-reality experience. For example, the handheld remote control device may be used to interact with the augmented-reality or virtual-reality generated environment.

For example, in some implementations, the handheld remote control device can be used to control a plurality of controllable devices. The handheld remote control device, a phone, glasses, or some other display device may provide an augmented-reality experience, in which the user can see options for the controllable devices, labels for the controllable devices, device groupings, and may see a variety of other content related to the environment, the controllable devices, and the functionality of the handheld remote control device. The handheld remote control device may be used to interact with these different content items displayed using the augmented-reality experience. For example, the handheld remote control device may be used to control or manipulate a controllable device by interacting with a rendered controllable device options menu. The augmented-reality environment may be updated through use of the handheld remote control device, such that the user may configure devices, generate groupings, and complete other actions while using the augmented-reality experience.

In some implementations, the handheld remote control device can be used as a controller inside a virtual-reality world provided by a virtual-reality experience. The handheld remote control device may be used to interact with a virtual environment to turn on a virtual fireplace, open a virtual cabinet, shoot a virtual bow, paint a virtual painting, move throughout a virtual world, change the settings of the virtual environment, etc. In some implementations, the virtual-reality experience may provide the ability to create a virtual-reality environment, and the handheld remote control device may be utilized to aid in generating the environment through gesture inputs, voice commands, button selections, touch screen selections, etc.

Moreover, in some implementations, the handheld remote control device can be used for playing various games such as interactive games using one or more of the controllable devices. For example, in some implementations, the various controllable devices can be used as part of the game interface. In one example, the handheld remote control device can communicate with one or more controllable devices to light up and/or make a sound. The controllable devices that light-up and/or make a sound can prompt the user to take a specific action, which can include pointing the handheld remote control device at the specific controllable device. In some implementations, the action can be a button selection. The handheld remote control device can then generate inertial data, UWB data, and/or image data in order to determine a user action. Determining the user action can involve processing the generated data to determine an orientation which can be used to determine a controllable device being targeted. If the correct controllable device is targeted, the system may provide a positive feedback, and if an incorrect controllable device is target, the system may provide a negative feedback. The system can also determine an elapsed time or an order of a user's actions to determine if the user action occurred in a satisfactory amount of time and/or determine if a desired order is followed. The system may keep track of a user's score based on timely and correct actions.

In one example, the environment can have a set of light bulbs, televisions, and/or monitors that can be illuminated. The desired action in the game can include instructing the user to select a controllable device being illuminated during a certain period of time. The period of time may include concurrently selecting the controllable device while the controllable device is illuminated or may include selecting the controllable device during a specific period of time during and/or after the illumination. Feedback may be provided after each successful action and/or after every unsuccessful action. Selecting the controllable device can involve the use of one or more of an inertial sensor, an image sensor, or a UWB transceiver to determine a handheld remote control device orientation, which can be used to determine the controllable device being targeted by the user. Moreover, in some implementations, selecting a controllable device can involve one or more button selections, one or more audio inputs, and/or one or more gesture inputs. A user's score may be tracked and provided via a visual display and/or via a speaker system.

In another example, the environment can have a set of light bulbs, televisions, and/or monitors that can be illuminated. The game can involve illuminating a plurality of lights, monitors, and/or televisions in a specific order and can then instruct the user to select the plurality of illuminated objects in the same order as had been illuminated. In some implementations, the illuminating controllable devices can be illuminated in different colors and may be paired with respective audio responses. The system can set an order for illumination, send instructions to the controllable devices to illuminate at a given time, and then generate sensor data to determine if the user completed the correct actions indicative of the correct selections and order. Correct selections in the correct order may lead to the system providing positive feedback, and incorrect selections may lead to the system providing negative feedback.

The systems and methods disclosed herein can involve localized processing on the handheld remote control device such that environment mapping and controllable device manipulation can be determined and processed locally on the handheld remote controllable device using various computing components housed in the handheld remote control device. Alternatively, in some implementations, environment mapping and device control can involve communication with one or more assistant computing devices. Alternatively and/or additionally, one or more of the controllable devices may have one or more processing components to enable individualized device processing.

The systems and methods of the present disclosure provide a number of technical effects and benefits. As one example, the system and methods can generate an environmental map for enabling a handheld remote control device to control various controllable devices throughout an environment. The environment mapping can be completed using the handheld remote control device, and in some implementations, the environment spatial map may be stored locally on the handheld remote control device to limit the need for communication with a server computing system. The systems and methods can further be used to enable device grouping, which can allow a user to control multiple devices simultaneously which can save a user time. Furthermore, the systems and methods can enable drag-and-drop functions, which may allow a user to determine an action for a controllable device based on another object or device in the environment, which can save time for the user and provide a better user media experience.

Another technical benefit of the systems and methods of the present disclosure is voice-triggered search functionality. The handheld remote control device, or handheld interactive object, can be utilized for controlling devices in the environment, while also providing the functionality of generating searches based on user commands. The handheld remote control device can receive a voice command, process the command, capture an image, and receive search results for a user related to an object or device in the environment. The search functionality can save a user time and provide a device that can help with understanding products consumed by a user.

With reference now to the Figures, example embodiments of the present disclosure will be discussed in further detail.

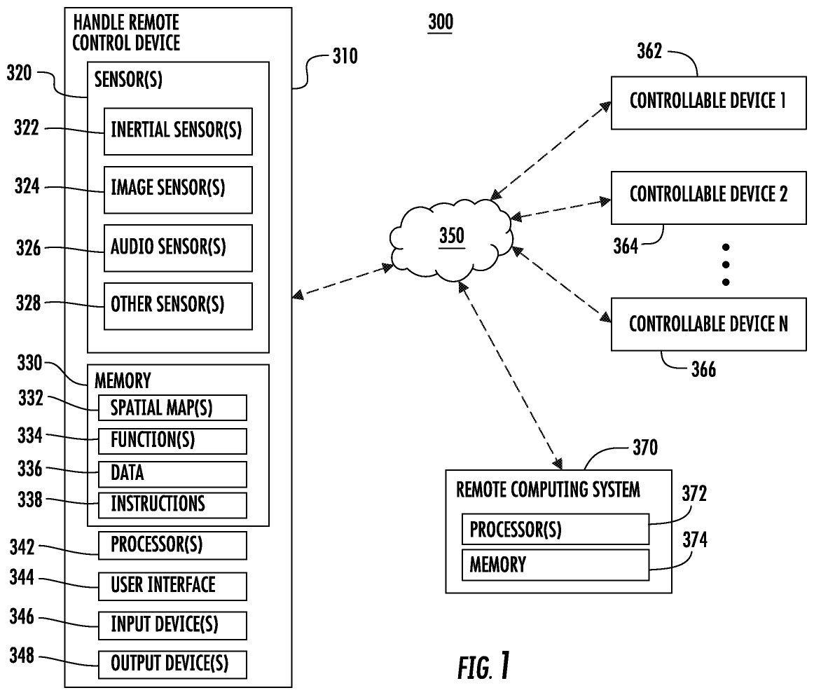

FIG. 1 depicts a block diagram of an example computing system 300 that performs environment mapping and controllable device manipulation according to example embodiments of the present disclosure. The system 300 includes a handheld remote control device 310, a plurality of controllable devices 362, 364, & 366, and one or more remote computing system(s) 370 that communicate over a network 350. The remote computing system(s) can include an assistant computing system in example embodiments.

The handheld remote control device 310 can include a plurality of sensors 320 configured to perform environment mapping and for receiving inputs. More specifically, in some implementations, the handheld remote control device 310 may include one or more inertial sensors 322 (e.g., inertial measurement units (IMU)), one or more image sensors 324 (e.g., cameras), one or more audio sensors 326 (e.g., microphones), and/or one or more other sensors 328 (e.g., pressure sensors, accelerometers, proximity sensors, infrared sensors, etc.). The one or more inertial sensors 322 can be used to generate inertial data to determine an orientation of the handheld remote control device 310. The inertial data may be used in combination with one or more additional sensors such as image sensors, ultra-wideband sensors, etc. to generate an environment spatial map 332 with controllable device location information. The inertial data may also be used to determine an orientation of the handheld remote control device 310, which can be used to determine an intended device for control. For example, the orientation and the spatial map 332 can be processed to determine which of the controllable devices 362, 364, & 366 the handheld remote control device 310 is pointed to or is otherwise intended for control by a user.

The one or more image sensors 324 can be used to generate image data. The image data can be utilized for generating the environment spatial map 332. For example, the image data can be descriptive of a plurality of images of the environment and can be processed to generate depth information. The depth information can then be leveraged to generate the spatial map 332.

The image data can also be used for handheld remote control device 310 enabled searching. In some implementations, the image data may be generated in response to a voice command and may be used to generate a search query. The search query may be sent via the network 350 to a remote computing system 370 to process the search query. The search results can then be sent back to the handheld remote control device 310 to provide to a user.

The one or more audio sensors 326 can be used to generate audio data in response to a voice command. For example, the audio sensors 326 can be used to enable voice controls. Voice controls can include commands to add names to the spatial map 332 for particular controllable devices 362, 364, & 366 or particular device groupings. Voice controls may include commands to control particular controllable devices 362, 364, & 366. In some implementations, the voice control can include a command that when processed triggers a search function.

The one or more other sensors 328 can be used for receiving input data, for aiding in environment map generation, device communication, or for determining the intended controllable device.

In some implementations, the handheld remote control device 310 can include one or more memory components 330 for locally storing information, which can include storage of the one or more spatial maps 332 and/or one or more functions 334. The handheld remote control device 310 can store the spatial maps 332 for quick recall, and the handheld remote control device 310 may be configured to store the spatial map with controllable device location information. In some implementations, the handheld remote control device can store a spatial map 332 for each controllable environment. The spatial maps 332 may be updated in response to the addition of new devices, new groupings, and/or new labels. The stored functions 334 can be pre-programmed functions or may be user programmed functions.

Moreover, in some implementations, the handheld remote control device 310 can include one or more processors 342 for processing data to determine actions or generate data and can include a user interface 344 for intaking user input and outputting information to the user. The user interface 344 can include visual feedback through one or more lights or a visual display (e.g., LCD display, touch screen display, etc.). Moreover, the user interface 344 may provide feedback via audio notifications or feedback using one or more speakers, and in some implementations, the user interface 344 may provide haptic feedback using one or more haptic devices. Example haptic devices may include eccentric rotating mass (ERM) motors and/or linear resonant actuators (LRA). The user interface 344 can enable effective handheld remote control device 310 operation and may add intuitive feedback and aid in overall use.

The handheld remote control device 310 can communicate with a plurality of controllable devices 362, 364, & 366 and/or a remote computing system 370 such as an assistance computing system over a network 350. In particular, the handheld remote control device 310 can use the network 350 to communicate with the plurality of controllable devices 362, 364, & 366 in the environment. In some implementations, the environment may include one controllable device 362 or an n number of controllable devices. For example, the environment may include a first controllable device 362 that is a television, a second controllable device 364 that is a speaker system, and an Nth controllable device 366 that is a smart light fixture. The handheld remote control device 310 can use the network 350 to control these devices individually or in any combination. In some examples, the handheld remote control device 310 can communicate with controllable devices directly.

In some implementations, the handheld remote control device 310 may utilize a remote computing system 370 to control one or more of the controllable devices. For example, the handheld remote control device 310 may generate a search query locally but may send the search query to the remote computing system 370 for processing the search query to determine search results. Moreover, the remote computing system 370 may be utilized to aid in generating the environment spatial map 332 by providing a reference point or by providing an interface for adding devices to the network 350. In some examples, the handheld remote control device 310 may provide selected device actions or commands to the remote computing system 370, which in turn can provide an appropriate command to the corresponding controllable device(s).

The remote computing system 370 can include a variety of components including one or more processor(s) 372, one or more memory components 374, one or more sensors, a display, and/or one or more speakers. The remote computing system 370 can be a smart assistant (e.g., a Google Home). In some implementations, the remote computing system can include a personal computing device (e.g., laptop or desktop), a mobile computing device (e.g., smartphone or tablet), a gaming console or controller, a wearable computing device, an embedded computing device, and/or any other type of computing device.

Moreover, in some implementations, the handheld remote control device 310 and the controllable devices 362, 364, and 366 may communicate via one or more near range communication protocols (e.g., BLE protocol, etc.) or may be configured to communicate via one or more network(s) 350.

In some implementations, the handheld remote control device 310 can include one or more computing device(s). The computing device(s) can include one or more processor(s) 342 and one or more memory device(s) 330. The one or more processor(s) 342 can be any suitable processing device (e.g., a processor core, a microprocessor, an ASIC, a FPGA, a controller, a microcontroller, etc.) and can be one processor or a plurality of processors that are operatively connected. The memory device(s) 330 can include one or more non-transitory, computer-readable media that collectively store instructions that when executed by the one or more processors 342 cause the one or more processors 342 (the handheld remote control device) to perform operations. The memory device(s) 330 can include one or more non-transitory, computer-readable storage media, such as RAM, ROM, EEPROM, EPROM, flash memory devices, magnetic disks, etc., and/or combinations thereof.

The memory device(s) 330 can store information accessible by the one or more processor(s) 342, including computer-readable instructions 338 that can be executed by the one or more processor(s) 342. The instructions 338 can be any set of instructions that when executed by the one or more processor(s) 342, cause the one or more processor(s) 342 (the handheld remote control device) to perform operations. In some embodiments, the instructions 338 can be executed by the one or more processor(s) 342 to cause the one or more processor(s) 342 to perform operations, such as any of the operations and functions of a handheld remote control device (and/or its hardware components) or for which the handheld remote control device (and/or its hardware components) are configured, as described herein, one or more portions of any of the methods/processes described herein, and/or any other operations or functions, as described herein. The instructions 338 can be software written in any suitable programming language or can be implemented in hardware. Additionally, and/or alternatively, the instructions 338 can be executed in logically and/or virtually separate threads on processor(s) 342.

The one or more memory device(s) 330 can also store data 336 that can be retrieved, manipulated, created, or stored by the one or more processor(s) 342. The data 336 can include, for instance, data indicative of user input, data indicative of a pairing communication, data indicative of a controllable device identifier, data indicative of a pairing output signal, sensor data, data indicative of a controllable device action, data associated with an unpairing action, algorithms and/or models, data indicative of haptic feedback, data indicative of successful pairing/action completion, and/or other data or information. The data 336 can be stored in one or more database(s). The one or more database(s) can be connected to the handheld remote control device 310 by a data channel, by a high bandwidth LAN or WAN, or can also be connected to the handheld remote control device 310 through network(s) 350. The one or more database(s) can be split up so that they are located in multiple locales.

The handheld remote control device 310 can also include a communication interface 344 used to communicate with one or more other component(s) of the system 300 including, for example, near range and/or over the network(s) 350. The network interface 344 can include any suitable components for interfacing with one or more network(s), including for example, transmitters, receivers, ports, controllers, antennas, chips, or other suitable components.

The handheld remote control device 310 can include one or more input devices(s) 346 and/or one or more output devices(s) 348. The input devices(s) 346 can include, for example, hardware and/or software for receiving information from a user (e.g., user input). This can include, for example, one or more sensors (e.g., inductive sensors, IMUs, etc.), buttons, touch screen/pad, data entry keys, a microphone suitable for voice recognition, etc. The output device(s) 348 can include hardware and/or software for visually or audibly producing signals. For instance, the output device(s) 348 can include one or more lighting elements (e.g., LED, ultrasound emitter, infrared emitter, etc.), display device, one or more speaker(s), etc.

The remote computing system 370 can be any suitable type of computing device, as described herein. The remote computing system 370 can include one or more processor(s) 372 and one or more memory device(s) 374. The one or more processor(s) 372 can include any suitable processing device, such as a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs) (e.g., dedicated to efficiently rendering images), processing units performing other specialized calculations, etc. The memory device(s) 374 can include one or more non-transitory, computer-readable media that collectively store instructions that when executed by the one or more processors 372 cause the one or more processors 372 to perform operations. The memory device(s) 374 can include one or more non-transitory, computer-readable storage media, such as RAM, ROM, EEPROM, EPROM, flash memory devices, magnetic disks, etc., and/or combinations thereof.

The memory device(s) 374 can include one or more computer-readable media and can store information accessible by the one or more processor(s) 372, including instructions that can be executed by the one or more processor(s) 372. For instance, the memory device(s) 374 can store instructions for running one or more software applications, displaying a user interface, receiving user input, processing user input, pairing/unpairing with an interactive object, performing user device actions, etc. The instructions can be executed by the one or more processor(s) 372 to cause the one or more processor(s) 372 to perform operations of the user device(s) (or for which they are configured) as described herein, one or more portions of any of the methods/processes described herein, and/or any other operations or functions, as described herein. The instructions can be software written in any suitable programming language or can be implemented in hardware. Additionally, and/or alternatively, the instructions can be executed in logically and/or virtually separate threads on processor(s) 372.

The one or more memory device(s) 374 can also store data that can be retrieved, manipulated, created, or stored by the one or more processor(s) 372. The data can include, for instance, data indicative of a user input, data indicative of a network communication, data indicative of an interactive object identifier, data indicative of a control for a controllable device, sensor data, data indicative of an interactive object action, data associated with environment mapping, data indicative of pairing data structure, data indicative of a user device action, data indicative successful communication and/or actions, algorithms and/or models, and/or other data or information. In some implementations, the data can be received from another device.

The remote computing system 370 can also include a network interface used to communicate with one or more other component(s) of system 300 (e.g., the handheld remote control device 310) via near range communication and/or over the network(s) 350. The network interface can include any suitable components for interfacing with one or more network(s), including for example, transmitters, receivers, ports, controllers, antennas, or other suitable components.

The remote computing system 370 can include one or more input devices(s) and/or one or more output devices(s). The input devices(s) can include, for example, hardware and/or software for receiving information from a user, such as a touch screen, touch pad, mouse, data entry keys, a microphone suitable for voice recognition, etc. In some implementations, the input device(s) can include sensor(s) for capturing sensor data (e.g., associated with a pairing output signal, interactive object action, voice command, etc.). The output device(s) can include hardware and/or software for visually or audibly producing information/signals for a user. For instance, the output device(s) can include one or more speaker(s), earpiece(s), headset(s), handset(s), etc. The output device(s) can include a display device, which can include hardware for displaying a user interface and/or messages for a user. By way of example, the output component can include a display screen, CRT, LCD, plasma screen, touch screen, TV, projector, and/or other suitable display components. In some implementations, the handheld remote control device 310 may not include a display device.

The network(s) 350 can be any type of communications network, such as a local area network (e.g., intranet), wide area network (e.g., Internet), cellular network, or some combination thereof and can include any number of wired and/or wireless links. The network(s) 350 can also include a direct connection between one or more component(s) of system 300. In general, communication over the network(s) 350 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

For data transmission described herein, data transmitted from one device to another may be transferred directly or indirectly. For example, data transmitted from one device to another may be transferred directly from one device to another without an intermediate device or system. Data transmitted from one device to another may be transferred directly from one device to another with an intermediate device or system. The data may be altered, processed, or changed in some way by the intermediate device or system.

In some implementations, the computing systems disclosed herein can include one or more machine-learned models stored locally on the handheld remote control device, on a server computing system, or may be configured in various other configurations.

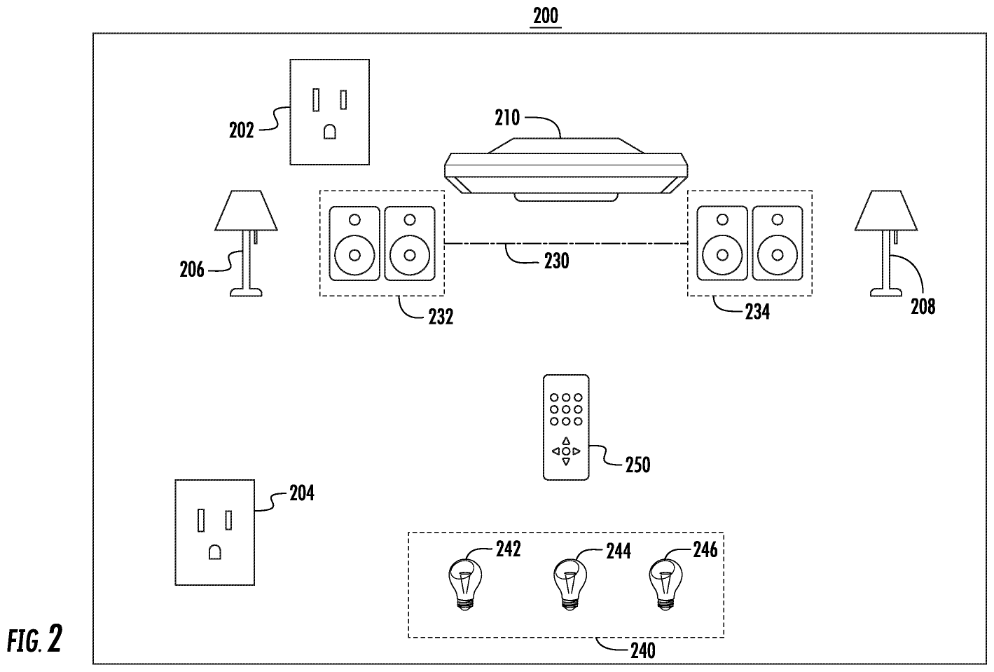

FIG. 2 depicts an illustration of an example environment 200 including a handheld remote control device and a plurality of controllable devices in accordance with example aspects of the present disclosure. The example environment 200 includes a room with a plurality of controllable devices, including smart outlets 202 and 204, lamps 206 and 208, speakers 232 and 234, a television 210, and light fixtures 242, 244, and 246. Such an environment may be referred to as a controllable space in some examples.

The handheld remote control device 250 may be used to map the environment 200 and control each device in the environment 200. In some implementations, the handheld remote control device 200 may use a generated spatial map and location information from the environment mapping to determine which controllable device is intended to be controlled by the user.

Environment mapping can begin with capturing a plurality of images of the environment with a camera included in the handheld remote control device 250. The images may be captured during an environment 200 walk through or by a user pivoting about one or more points in the environment 200. The images can be processed to determine position information such as distance and/or depth information, which can be used to generate a spatial map. The images can be processed to determine distances between features and/or objects. In some examples, multiple images may be processed to determine distances between features so that a spatial map representative of actual dimensions, positions, and/or locations associated with the environment can be determined. The handheld remote control device 250 may receive an input associated with a respective controllable device and motion data from one or more inertial sensors included in the handheld remote control device 250. The input and motion data can be processed to determine a location for the respective controllable device. The location can be used to generate location information for the controllable device to be stored with or as part of the spatial map. The process may be repeated for each controllable device in the environment 200.

Once the environment 200 is mapped, the controllable devices may be controlled by the handheld remote control device 250. For example, the handheld remote control device 250 may be used to group devices. The light fixtures 242, 244, and 246 may be grouped after the handheld remote control device 250 obtains a first input, motion data, and a second input. The first input may be a button compression, while the second input may be a button decompression. Alternatively and/or additionally, one or both of the inputs may be audio data descriptive of voice commands. The motion data can include data generated by one or more inertial sensors included in the handheld remote control device 250. The motion data can be processed to determine a user intent. In this example, the motion data includes data descriptive of a lasso gesture that encompasses the light fixtures 242, 244, and 246, which can be processed to determine a user intent to group the light fixtures 242, 244, and 246. A light fixture grouping 240 may then be generated and stored locally on the handheld remote control device 250.

Alternatively and/or additionally, a device grouping may be generated via voice command or through configuration on a touch screen. In some implementations, the handheld remote control device 250 may obtain audio data descriptive of a device label or device grouping label to generate names or labels for devices and device groupings in the environment 200. For example, the handheld remote control device 250 may obtain a voice command to label the speaker grouping 230 as “my sound system,” such that when a user gives the voice command to “turn up my sound system” both the first speaker system 232 and the second speaker system 234 will have their volume raised.

Moreover, the handheld remote control device 250 can utilize the spatial map, the location information, and the inertial sensors to accurately determine the controllable device the user intends to control. For example, the location information and the spatial map may be used to determine device zones, such that if the handheld remote control device 250 is pointed anywhere inside that respective device's zone, the handheld remote control device will determine the respective device as the intended device. More particularly, the whole back left region of the environment 200 may be a control zone for the second outlet 204, while the front right corner may be a much smaller control zone for the second lamp 208. Moreover, the spatial map and location information may include three dimensional data, such that the speaker grouping 230 and the television 210 may share the same point on two axes but may be controlled individually due to a third axis point direction determination.

In some implementations, the intended device may be determined based on a voice command. For example, the first lamp 206 and the first outlet 202 can be labeled “first lamp” and “first outlet” respectively, and in response to a “turn off the first lamp” voice command, the handheld remote control device 250 may send instructions to the lamp to turn off even if the handheld remote control device 250 is pointed at the first outlet control zone.

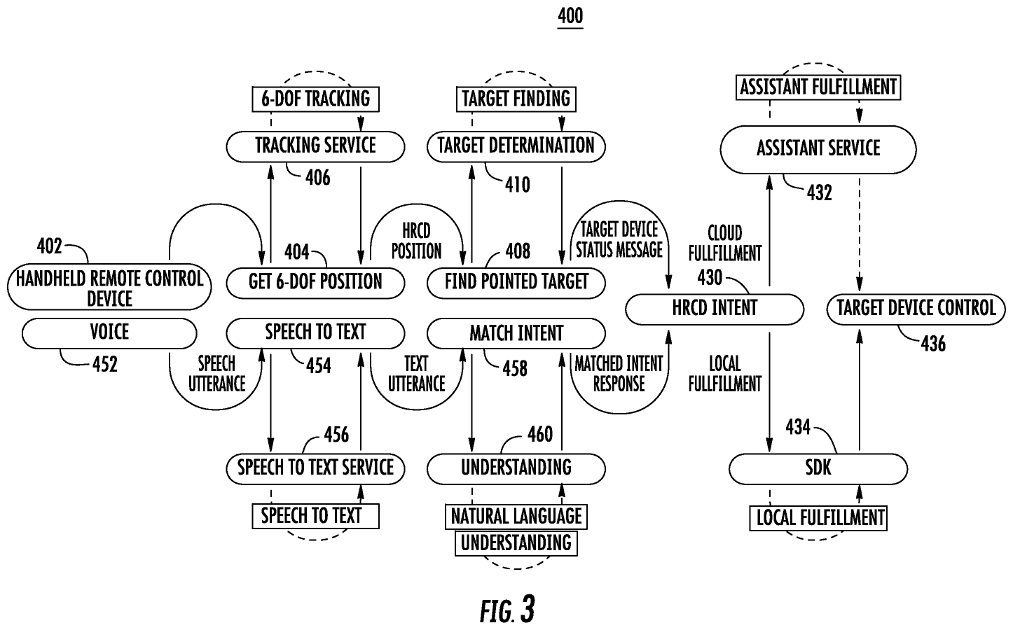

FIG. 3 depicts a block diagram of an example computing system including a set of software components 400 according to example embodiments of the present disclosure. More specifically, the example set of software components 400 in FIG. 3 depicts parallel processing of motion data and audio data to control a target device. Both the motion data and the audio data can be obtained, processed, and used to determine an intent, which can include a target device control for fulfillment.

The handheld remote control device 402 can obtain motion data from one or more inertial sensors included in the handheld remote control device. The motion data can be used to determine a six degrees of freedom position information 404. The handheld remote control device can utilize a local and/or remote tracking service 406, which can determine the six degrees of freedom position information using six degrees of freedom tracking. The handheld remote control device position can then be processed to determine a pointed target at 408. Determination of the pointed target at 408 can include the use of a local and/or remote target determination service 410, which can utilize the spatial map and location information for target finding. The handheld remote control device can determine a selected controllable device as the determined target at 408 based on the output of the target determination service. In combination with one or more additional inputs, an intent associated with the remote control device can then be determined.

The handheld remote control device or a connected device may obtain audio data including a voice command 452. The voice command 452 can include a speech utterance and may be processed to generate text data 454 descriptive of the speech utterance. Generating text data by processing the audio data can involve using a local and/or remote speech to text service 456. The generated text utterance can then be processed to determine an intent 458 of the voice command. The text utterance can be sent to an understanding service for natural language understanding in order to match the text utterance to a determined intent.

The selected controllable device determined at 408 and the matched intent response determined at 458 can be used to determine a handheld remote control device intent 430.

Determining the handheld remote control device intent 430 can include understanding a type of the target controllable device and determining how the matched intent response applies to that specific device type. For example, a sound system and a television may have different capabilities. Once an intent is determined, the desired action can be fulfilled via cloud fulfillment using an assistant service or via local fulfillment using a software development kit (SDK) or other technique. A target device control 436 can be determined. For example, the voice command 452 can include “turn on this device” while pointing at a television, and in response to the processing steps, the target device control 436 may include turning the television on.

The plurality of services that can be utilized for determining a target device control may be provided locally on the handheld remote control device or may be provided via a wireless connection to a computing system.

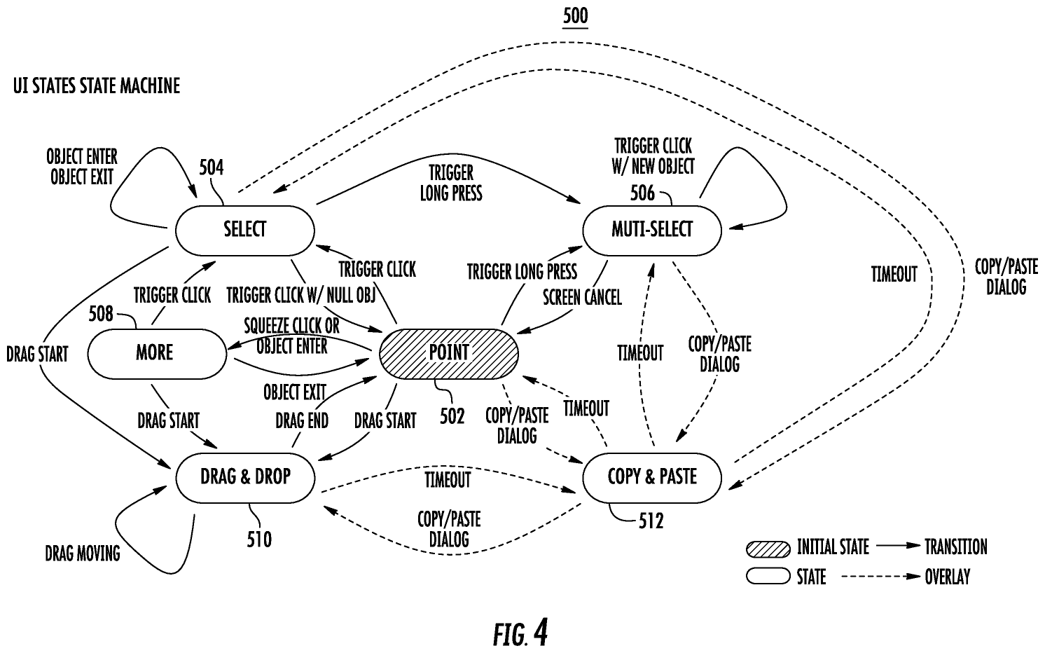

FIG. 4 depicts a block diagram of a handheld remote control device including an example UI state machine 500 according to example embodiments of the present disclosure. In some implementations, the UI state machine 500 can include various logic paths descriptive of different inputs.

Once a handheld remote control device has mapped an environment, the handheld remote control device can be used to control the plurality of controllable devices in that environment. Control of the controllable devices can rely on inputs collected by the handheld remote control device. The inputs can be singular inputs or clustered inputs which can be processed and determined to have particular intents. For example, a drag and drop 510 input can be determined to have the intent of determining the content (e.g., audio or video) provided by a first device and provided associated content on a second device.

A handheld remote control device can intake point 502 inputs to determine a device the user intends to control. The point 502 input can be processed with the spatial map and location information to determine the intended controllable device. In some implementations, the point 502 input may be paired with one or more following inputs or precursor inputs. For example, the point 502 input may be paired with a trigger click or button compression to select 504 a controllable device. In some implementations, a user may hold the trigger or the selection button while pointing at multiple controllable devices to complete a multi-select 506 function.

In some implementations, the input may include audio input including human speech. The dialog input can include a copy/paste dialog. For example, the user may point at a first controllable device and provide a voice command to copy from that device then point at a second controllable device and provide a paste command. The inputs can be processed to determine a copy & paste 512 intent. The resulting output may include providing the same or related content on the second controllable device from the first controllable device. In some implementations, copy & paste 512 can involve a drag and drop input.

FIG. 4 depicts a point 502 initial state, a select 504 state, a multi-select 506 state, a drag & drop 510 state, and a copy & paste 512 state. However, one or more other 508 states may be included. The inputs for each respective state can stem from the point input or may be independent from the point input. The inputs can be from trigger compressions, other button compressions, audio inputs, motion inputs, and/or image inputs.

While example embodiments are described with respect to handheld remote control devices, it will be appreciated that embodiments of the present disclosure may be implemented with other form factors such as a wearable remote control device. By way of example, a wearable remote control device may include a strap or other attachment member for physical coupling the remote control device to or with a user. Examples of wearable devices include but are not limited to wearable garments, smart watches, fitness trackers and the like.

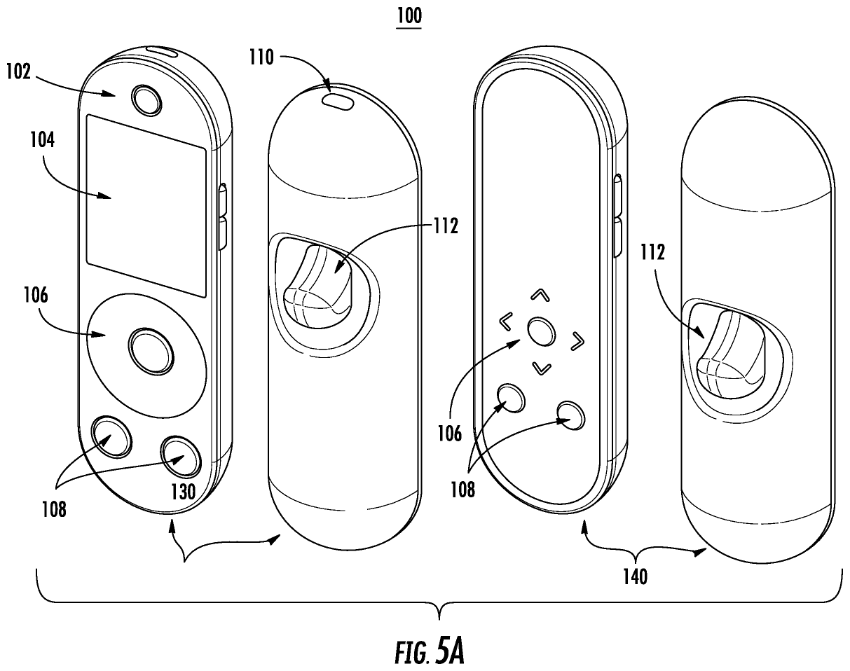

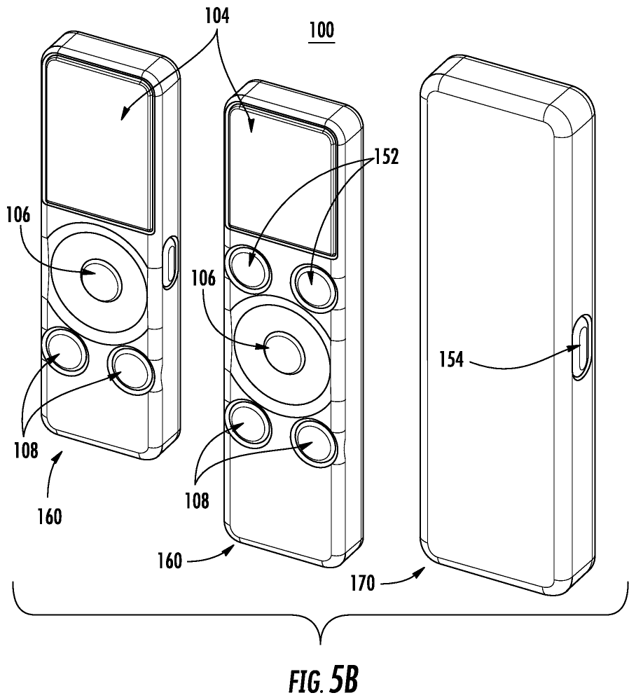

FIG. 5A depicts an illustration of two example handheld remote control devices 100. The first example handheld remote control device 130 includes a top button 102, a display screen 104, a direction pad (D-pad) 106 with a center selection button, two bottom buttons 108, a window 110, and a trigger button 112. The top button 102 can be a home button configured to complete various tasks. In some implementations, the home button can bring up an option menu on the display screen 104 of various options for interacting with the environment or a specific controllable device. In some implementations, the top button 102 can be used as an on or off button for the controllable device the handheld remote control device is pointing to.

The display screen 104 can be a touch screen or purely for display. The display screen 104 can include a liquid crystal display, a light-emitting diode display, a plasma display, or any other form of display. The display screen can be utilized to display options for interacting with the environment, options for controlling devices in the environment, or may display optional applications the user wishes to use.

The D-pad 106 can include four underlining directional buttons. The directional buttons can include an up, a down, a right, and a left. The first example handheld controllable device 130 includes a ring D-pad 106, which can be pressed in between adjacent directional buttons to provide a combination command. For example, the upper left portion of the ring D-pad 106 may be pressed, which can cause an up and left command simultaneously. Combination commands, and directional commands in general, can be used for navigating options, for games, or for providing other forms of input. In some implementations, the central button enclosed by the D-pad 106 can be used as a selection button or another type of button dependent on device configuration.

The bottom buttons 108 can be programmed to complete various tasks. For example, the bottom two buttons 108 may be used to toggle between devices, change channels, change the volume of a device, or complete specific commands. For example, the bottom right button may be configured as a source/AUX/HDMI button, while the bottom left button may be configured as a back button.

The trigger button 112 may be utilized for gaming functions or may be configured similarly to the other buttons on the handheld remote control device. In some implementations, the trigger button 112 can have various compression levels that complete various commands. For example, a light compression (e.g., ¼ compression with respect to the full range of motion) may prompt a fast forward at a 1.5× rate, a half compression may prompt a fast forward at a faster rate (e.g., 2× rate), and a full compression may prompt a fast forward at an even faster rate (e.g., 4× rate).

The window 110 can be used to provide protection to one or more sensors or components of the handheld remote control device, while providing a transparent to slightly transparent window to the environment. The window 110 can allow light or laser waves to enter or leave the handheld remote control device. In some implementations, the window 110 can protect one or more image sensors (e.g., one or more cameras). The one or more image sensors can obtain image data descriptive of the environment, while being protected by the window 110.

The second example handheld remote control device 140 is similar to the first example handheld remote control device 130. The second example handheld remote control device 140 includes an alternate D-pad 106 design while omitting a display screen 104 and top button 102. In this implementation, the D-pad 106 includes four directional buttons that can be used for navigation purposes, for changing volume and channels, or for selection purposes. In various examples, different display types may be provided or a display may be omitted.

In some implementations, one or both examples may have one or more side buttons that can be configured or programmed to complete various tasks.

FIG. 5B depicts an illustration of two example handheld remote control devices (i.e., a third example and fourth example). More particularly, FIG. 5B depicts the front 160 of the two example handheld remote control devices and the back 170 of the third example. Both examples include a display screen 104, a D-pad 106 with a center button, and two bottom buttons 108. The fourth example handheld remote control device includes two additional buttons 152 above the D-pad 106. The third example handheld remote control device includes two side buttons 154. The display screens 104, D-pads 106, and bottom buttons 108 of the third and fourth example may be analogous to the components of the first example 103. Each of the additional buttons 152 or the side buttons 154 can be programmed for different uses to provide different intents when compressed.

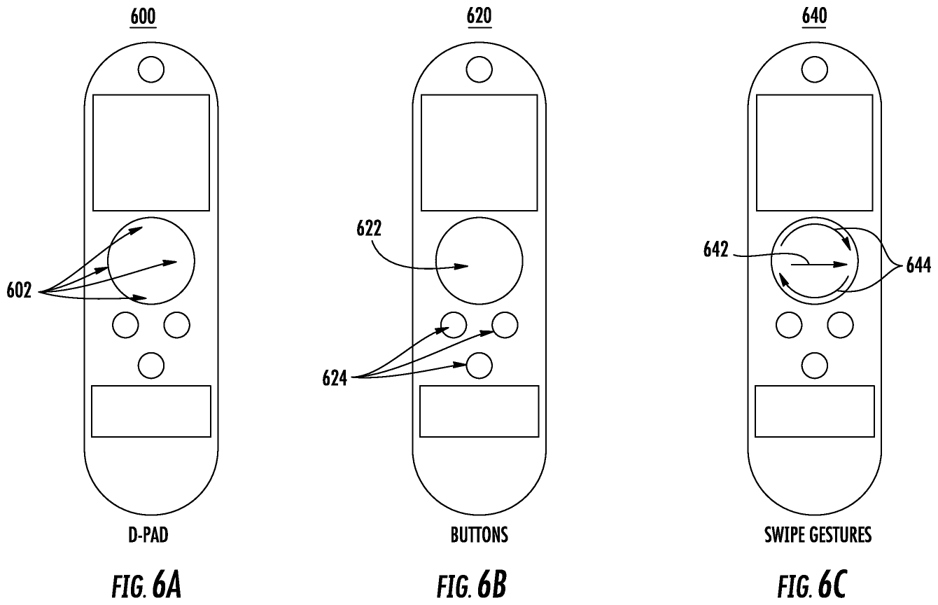

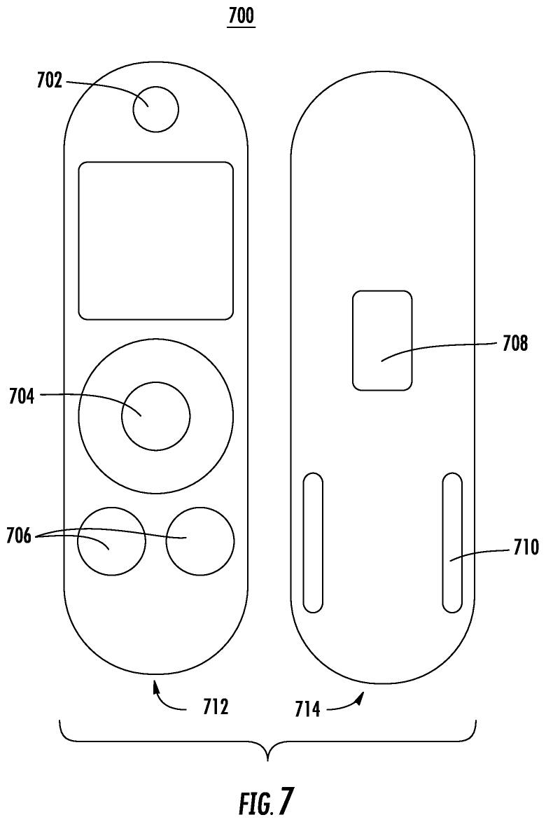

FIGS. 6A-6C depict example illustrations of example handheld remote control devices 600, 620, and 640. The figures depict three example input methods according to example embodiments of the present disclosure.

FIG. 6A depicts an example illustration of an example handheld remote control device 600 with the D-pad 602 being highlighted by the plurality of arrows. The D-pad 602 can include a plurality of directional buttons (e.g., an up button, a down button, a right button, and a left button) or can include a ring or circle. The D-pad 602 can be programmed for a variety of uses including navigational uses. For example, the D-pad 602 may be used to navigate among a plurality of applications on a smart television. In some implementations, the top of the D-pad and the bottom of the D-pad may be paired, while the left part of the D-pad and the right part of the D-pad may be paired. For example, the top of the D-pad and the bottom of the D-pad (e.g., up button and the down button) may be used to change channels, change a device brightness, or toggle options. Moreover, the left portion of the D-pad and the right portion of the D-pad (e.g., left button and right button) may be used to change the device volume, the device color, or change menus.

FIG. 6B depicts an example illustration of an example handheld remote control device 620 with four compression buttons 622 and 624 being highlighted by the plurality of arrows. The compression buttons 622 and 624 can have preset functions or can be programmed by the user to have user-specific functions. In some implementations, the D-pad 602 can include a center button 622 that may be used as a selection button for navigational purposes or may act alone. The three buttons 624 below the D-pad 602 can be correlated or may have separate uses altogether. In some implementations, the handheld remotes control devices 600, 620, and 640 may have varying numbers of compression buttons 622 and 624. For example, in some implementations, the handheld remote control device may have zero compression buttons, while in some implementations, the handheld remote control device may have four or more compression buttons.

FIG. 6C depicts an example illustration of an example handheld remote control device 640 configured to receive swipe gestures 642 and 644. The handheld remote control device 640 can obtain linear swipe gestures 642 or arced swipe gestures 644. The swipe gestures 642 and 644 may be received by a touchpad, a D-pad, or a touchscreen. Linear swipe gestures 642 may be obtained and processed to determine intent, in which the direction and magnitude may be understood as providing more context to the intent. Arced swipe gestures 644 can include circular gestures or semi-circular gestures. In some implementations, multiple swipe gestures may be received within a predefined period and processed as a group.

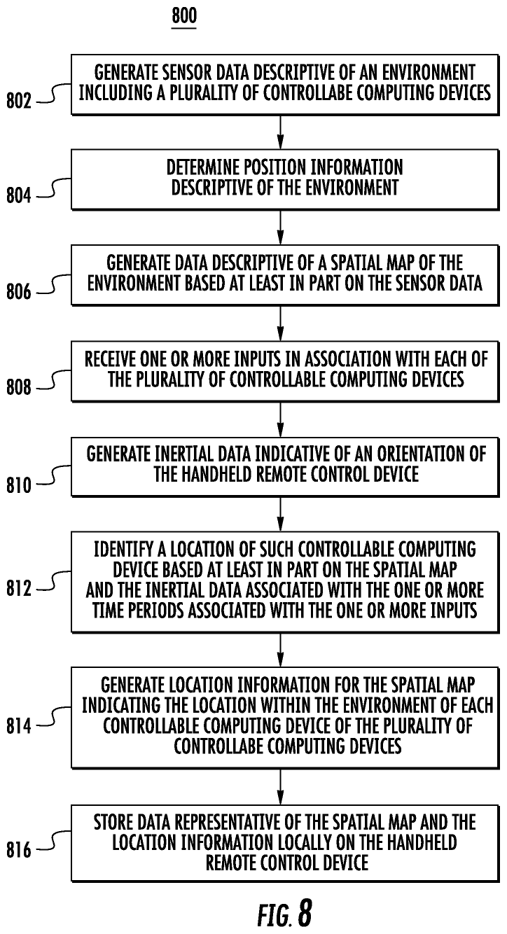

FIG. 7 depicts an illustration of another example handheld remote control device 700 according to example embodiments of the present disclosure. The front 712 can include a home button 702, a D-pad 704, and a universal button 706. The back 714 can include a trigger 708 and squeeze buttons 710.

An input received by the home button 702 can trigger the display of a home screen or option menu for the handheld remote control device 700. In some implementations, the home screen or option menu may be controllable device specific. The home screen or option menu may be displayed on a display screen on the handheld remote control device 700. Additionally and/or alternatively, in some implementations, the home screen or option menu may be displayed on the screen for the respective controllable device or via an augmented-reality rendering in an augmented-reality experience.

The D-pad 704 may be used to navigate options displayed on the controllable device or on the handheld remote control device 700. In some implementations, the D-pad 704 may have different intents for different types of controllable devices (e.g., the D-pad may control brightness and color for a light fixture, and channels and volume for a television).

The universal button 706, trigger 708, and squeeze buttons 710 can be configured to receive compression inputs. Each button may be configured or programmed for different functionality. For example, the trigger 708 may be used for drag and drop inputs, such that the trigger 708 can be compressed while pointed at a first device and decompressed when pointed at a second device.

The handheld remote control device can include a variety of hardware architectures. For example, the handheld remote control device can include one or more sensors inside the cavity of a device shell. The shell can be a size and shape that allows for a singular human hand to hold the handheld remote control device. In some implementations, the shell can include one or more other shapes (e.g., square, rectangular, hexagonal, octagonal, cylindrical, spherical, etc.). In some implementations, the handheld remote control device may include another type of form-factor such as, for example, a spherical form-factor. A handheld remote control device can include any device having one or more processors and at least one sensor. For example, a handheld remote control device may include a tablet computing device, smartphone, portable media player, etc. The handheld remote control device (and its portions/elements) can be constructed from one or more materials including, for example, polymers, metal, wood, composites, and/or one or more other materials.

The handheld remote control device can include a plurality of portions. For example, the handheld remote control device can include a first end/portion and a second end/portion. The first end/portion can include, for example, a home button 702 and a display. The second end/portion can include a universal button 706 and a squeeze button 710. In some implementations, the shell can include a material suitable for securing or comforting the grip of a user (e.g., rubber, polymer, ridged surface, padding, etc.).

The handheld remote control device can include an outer casing (e.g., an outer shell, layer, etc.) with an outer surface. In some implementations, at least a portion of the outer casing can be covered by another material. This can include, for example, a grip/comfort material for a portion of the handheld remote control device. The outer casing can include one or more diameters/widths. For example, the first end/portion can be associated with one or more first diameters. The second end/portion can be associated with one or more second diameters.

In some implementations, the handheld remote control device can include one or more devices for obtaining user input. For instance, the handheld remote control device can include one or more buttons on the faces of the handheld remote control device and one or more sensors housed in the cavity of the shell. The buttons can be located on any side of the handheld remote control device and may be disposed on any portion of the handheld remote control device. For example, the one or more buttons can be disposed of within a cavity formed by the outer casing. The one or more buttons can include an inductive sensor, a kinetic sensor, or a thermal sensor. The inductive sensor can include a coil with a metal casing surrounding the coil. The coil can be configured to detect a change in a magnetic field arising from a deformation of the metal casing. Such a deformation can be caused, for example, by a user input (e.g., a user physically gripping the handle of the handheld remote control device, etc.). Additionally, or alternatively, the handheld remote control device can include one or more interactive elements. This can include, for example, a touch screen, touchpads, and/or other features that a user can physically contact to provide user input.

In some implementations, the handheld remote control device can include a cavity. As described herein, the cavity can be an interior cavity of the handheld remote control device formed by the outer casing. Various hardware components for performing the functions of the handheld remote control device can be disposed within the cavity. The handheld remote control device can include a power source with an associated charging/fueling infrastructure. For example, the power source can include one or more batteries (e.g., lithium-ion batteries, lithium-ion polymer batteries, and/or other batteries) and the charging/fueling infrastructure can include wired and/or wireless (e.g., inductive, etc.) charging hardware. In some implementations, the handheld remote control device can include a haptic actuator and a printed circuit board. The haptic actuator can be configured to provide haptic feedback (e.g., vibration, etc.) to a user of the handheld remote control device. In some implementations, various hardware components can be secured to/within the handheld remote control device via a support structure. The support structure can include a mechanical spine or other structural element to which the various hardware components can be affixed. The support structure can be affixed to the outer casing (e.g., an interior surface thereof, etc.). In some implementations, the support structure can be temporarily affixed so that it can be removed for maintenance, replacement, update, etc. of the various hardware components.

In some implementations, the cavity and the various hardware components can include various dimensions. In some example implementations, one or more image sensors can be disposed towards a front portion of the handheld remote control device. For example, an image sensor may be in the cavity of the handheld remote control device 700 of FIG. 7 behind the home button. The handheld remote control device 700 can include a transparent window for the image sensor to capture the outside environment. Moreover, in some implementations, one or more inertial sensors can be disposed towards the front of the handheld remote control device; however, it should be appreciated that the inertial sensor may be in a middle portion or the back portion of the handheld remote control device. The handheld remote control device can include one or more audio sensors (e.g., microphones) disposed near a sound permeable opening in the shell. Furthermore, the one or more sensors may be connected to a circuit board with one or more processors, and the circuit board may be fixed to a side of the cavity. In some implementations, the handheld remote control device can include thermal pads for the one or more processors and/or may include one or more vents in the shell.

While various example form factors, input device arrangements, displays, and hardware architectures have been described, it will be appreciated that any or all of these components of the handheld remote control device may be modified for various implementations. Moreover, one or more of these components may be omitted in some embodiments.

Communication between the handheld remote control device, or a handheld interactive object, and one or more controllable devices can involve the utilization of a wireless connection (e.g., a WiFi connection or a Bluetooth connection). For example, each controllable device, or user device, may be connected to a network via WiFi or ethernet. Connecting the controllable devices to the network can be part of a configuration step that may include running an ethernet cable from a device port to an ethernet port, configuring a wireless connection on the device display, configuring a wireless connection with a mobile phone, configuring the wireless connection with the handheld remote control device, or configuring the wireless connection with another computing device.

In configuring the handheld remote control device connection with the controllable devices, the handheld remote control device can be connected to the network via a WiFi adapter, and the handheld remote control device may receive information on each controllable device on the network upon connection to the network. The handheld remote control device can then use the network to send instructions to the one or more controllable devices, such as changing a light bulb color, changing the channel on a television, raising the volume of a speaker system, turning off an outlet, etc. However, in some implementations, each controllable device in the environment may be paired with the handheld remote control device separately.

FIG. 8 depicts a flow chart diagram of an example method to generate and store a spatial map of an environment including a plurality of controllable devices according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a handheld remote control device can generate sensor data descriptive of an environment including a plurality of controllable computing devices. In some implementations, the sensor data can include image data descriptive of the environment. The image data can be generated using one or more image sensors included in the handheld remote control device. The image data can include images of different portions of the environment from different perspectives. In some implementations, the sensor data can additionally or alternatively include one or more additional sensors to aid in generating a spatial map. For example, in some implementations, ultra-wideband sensor data (UWB), inertial data and/or LiDAR data can be generated in place of or in addition to the image data.

In some implementations, the handheld remote control device can obtain network data descriptive of devices communicatively coupled using one or more networks before, after, or while generating sensor data. The network data can include registered devices in the environment. A registered device can include devices connected to the network and identifiable thereon. The device registration can be completed using the controllable device, o a mobile phone, the handheld remote control device, or any other computing device.

At 804, the handheld remote control device can determine position information descriptive of the environment. The position information can include depth information and/or distance information describing a depth of objects and/or features relative to a fixed position and/or distances between objects or features in the environment. In example embodiments, the position information can be determined using image recognition processing and/or image segmentation. In some implementations, the system may use ultra-wideband technology to determine the position information. The position information can be descriptive of the position of objects or features within the environment. By way of example, depth and/or spatial information associated with objects or features within the environment may be determined based on image data. The depths may be determined using image segmentation and/or other image analysis techniques. The depths can be determined using additional inertial data generated by one or more inertial sensors in some examples. As another example, UWB data may be determined at 804 that represents depth and/or spatial information of the environment.

At 806, the handheld remote control device can generate data descriptive of a spatial map of the environment based at least in part on the sensor data. The spatial map can include three dimensional point cloud data and may include spatial data based on three spatial axes. The map can be a three dimensional map, a three dimensional model, or a three dimensional point cloud data file. The spatial map may be generated based at least in part on the position information.

At 808, the handheld remote control device can receive one or more inputs in association with each of the plurality of controllable computing devices. The inputs can be compression inputs, gesture inputs, and/or voice command inputs.

At 810, the handheld remote control device can generate inertial data indicative of an orientation of the handheld remote control device. The inertial data can be generated using one or more inertial sensors included in the handheld remote control device. Moreover, the inertial data may be generated in response to the one or more inputs.

At 812, the handheld remote control device can identify a location of such controllable computing device based at least in part on the spatial map and the inertial data associated with the one or more time periods associated with the one or more inputs. In some implementations, the spatial map and the inertial data may be processed to determine the location. Moreover, in some implementations, the location for each device may be identified based on respective input data and inertial data. The inertial data and the input data may be processed to determine the location of one or more controllable devices using the spatial map. The remote control device may determine its orientation using the inertial data and its position within the environment based on the image data and a comparison to the spatial map. Based on the remote control device position and orientation, the remote control device can determine a location of a controllable device at which the remote control device is pointed. In some implementations, this step may be repeated for each controllable device in the environment. In some implementations, the determination process can further involve processing one or more images. Alternatively and/or additionally, the orientation can be determined by any combination of inertial data generated by an IMU, image data generated by an image sensor, or UWB data generated by one or more UWB transceivers.

At 814, the handheld remote control device can generate location information for the spatial map indicating the location within the environment of each controllable computing device of the plurality of controllable computing devices. The location information can be stored as data dependent on the spatial map or alternatively stored as independent data. For example, the spatial map can be modified to include data indicative of the location of each controllable device in the environment. In some examples, the spatial map is not modified and location information for each controllable device is stored in association with the spatial map. In some implementations, the handheld remote control device may obtain one or more audio data sets descriptive of controllable device labels, which can be included in the device map.

At 816, the handheld remote control device can store the spatial map and the location information locally on the handheld remote control device. In some implementations, the location information can be stored as coordinates with respect to the spatial map. The spatial map with location information can then be used to enable the handheld remote control device to control the plurality of controllable devices.

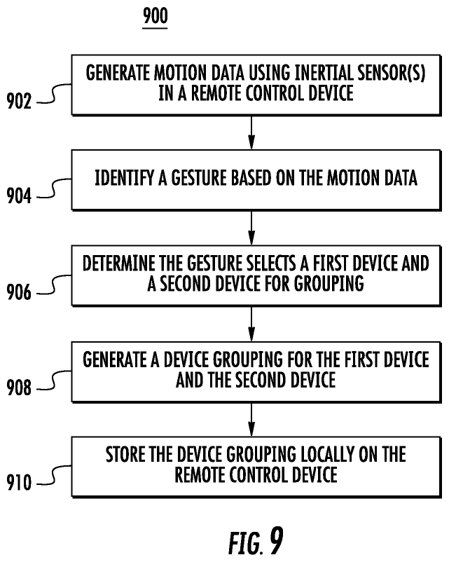

FIG. 9 depicts a flow chart diagram of an example method of grouping multiple controllable devices by a remote control device according to example embodiments of the present disclosure. Although FIG. 9 depicts steps performed in a particular order for purposes of illustration and discussion, the methods of the present disclosure are not limited to the particularly illustrated order or arrangement. The various steps of the method 900 can be omitted, rearranged, combined, and/or adapted in various ways without deviating from the scope of the present disclosure.

At 902, the handheld remote control device can generate motion data from a remote control device including one or more sensors. In some implementations, the remote control device can be a handheld remote control device that includes one or more inertial sensors, and the inertial sensors may be used to generate the motion data. Moreover, in some implementations, the handheld remote control device may generate image data with one or more image sensors, and the generated image data can be descriptive of the environment including one or more devices to be grouped.

At 904, the handheld remote control device can determine a gesture based on the motion data. In some implementations, the gesture can be a grouping gesture. The grouping gesture can include a lasso gesture, a linear gesture, or any type of gesture indicative of grouping.

At 906, the handheld remote control device can determine that the gesture selects a first device and a second device for grouping. The gesture can include a lasso gesture encompassing the first device and the second device. In some implementations, the gesture may select three or more controllable devices for grouping. The remote control device can determine that the first device and second device are selected for grouping by accessing a spatial map including three-dimensional coordinate information of the environment including location information for the plurality of controllable devices. The accessed data can then be used to identify the first device and the second device associated with the grouping gesture based at least in part on the movement data (i.e., motion data), the image data, and the spatial map.

At 908, the handheld remote control device can generate a device grouping for the first device and the second device. Moreover, in some implementations, the remote control device can obtain audio data descriptive of a device grouping name. The audio data can be processed to generate a device grouping label.

At 910, the handheld remote control device can store the device grouping locally on the remote control device. The device grouping can be stored with the device grouping label. The stored device grouping can enable the control of each device in the grouping simultaneously and/or as a whole. For example, in response to an input with the intended action to turn on the device grouping, all devices in the grouping may turn on.

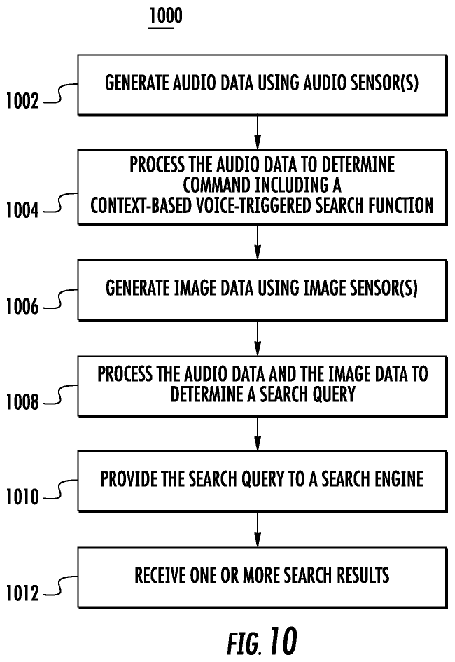

FIG. 10 depicts a flow chart diagram of an example method of processing audio data and using a spatial map to process a search query according to example embodiments of the present disclosure. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

At 1002, a handheld remote control device can generate audio data using one or more audio sensors. In some implementations, the audio sensor can be included in the handheld remote control device. Moreover, the computing system can also obtain a spatial map of an environment. The spatial map may be generated using depth information determined by processing one or more images of the environment.

At 1004, the handheld remote control device can process the audio data to determine a command including a context-based voice-triggered search function. Determining the command can involve processing the audio data with an analog-to-digital converter and processing the resulting data with a natural language processing model for natural language understanding.

At 1006, the handheld remote control device can generate image data using one or more image sensors. The image data can be obtained with one or more cameras included in the handheld interactive object and may be obtained in response to receiving a command. In some implementations, the image data can include one or more images of an object in the environment. Moreover, in some implementations, the object may be a consumer product.

At 1008, the handheld remote control device can process the audio data and the image data to determine a search query. The audio data may be processed to determine one or more search terms, and processing the image data may include image recognition processing or image segmentation. The search query can be a combination search query that includes one or more search terms and one or more images.

At 1010, the handheld remote control device can provide the search query to a search engine. The search engine can be a locally stored search engine or a search engine web service.

At 1012, the handheld remote control device can receive one or more search results. Moreover, in some implementations, one of the one or more search results may be provided via an audio notification or via a display.

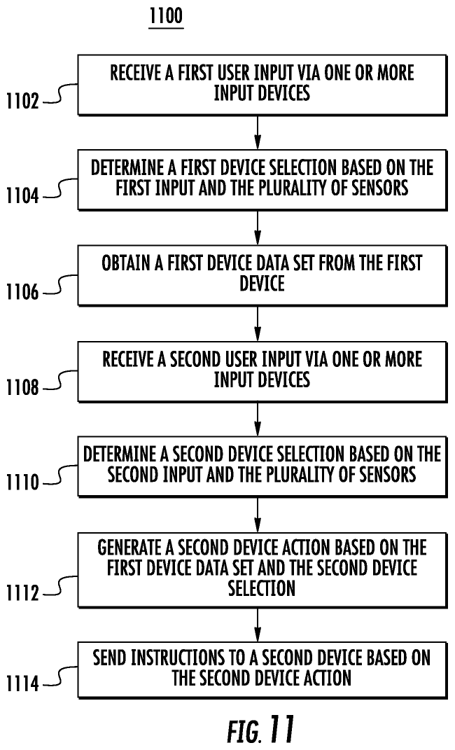

FIG. 11 depicts a flow chart diagram of an example method of controlling a second controllable device based on sensor data generated based on a first controllable device according to example embodiments of the present disclosure. Although FIG. 11 depicts steps performed in a particular order for purposes of illustration and discussion, the methods of the present disclosure are not limited to the particularly illustrated order or arrangement. The various steps of the method 1100 can be omitted, rearranged, combined, and/or adapted in various ways without deviating from the scope of the present disclosure.

At 1102, the handheld remote control device can receive a first user input via one or more input devices. The first input can be a compression input, gesture input, voice command input, or other suitable input.

At 1104, the handheld remote control device can determine a first device selection based on the first input and the plurality of sensors. The first device selection can be based at least in part on motion data generated by one or more inertial sensors. Alternatively and/or additionally, the first device selection can be based at least in part on one or more images generated by one or more image sensors.

At 1106, the handheld remote control device can obtain a first device data set from the first device. The first device data set can include images captured using a camera, data communicated over a wireless network, and/or audio data.

At 1108, the handheld remote control device can receive a second user input via one or more input devices. The second input can be a new button compression or the decompression of the button from the first input. In some implementations, the second input can be a voice command or a gesture. Moreover, in some implementations, the first input and the second input may be part of a drag and drop input that can include a button compression at one device with a motion to a second device, and at which time the handheld remote control device is pointing at the second device, the button is decompressed.

At 1110, the handheld remote control device can determine a second device selection based on the second input and the plurality of sensors. The determination can involve obtaining and processing motion data from one or more inertial sensors.

At 1112, the handheld remote control device can generate a second device action based on the first device data set and the second device selection. Generating a second device action can involve determining the content of the first device data set and the device type of the second device selected by the second device selection. In some implementations, generating the second device action can include determining an associated content item to the content item of the first device data set, in which the associated content item can be played or displayed by the second device.

At 1114, the handheld remote control device can send instructions to a second device based on the second device action.

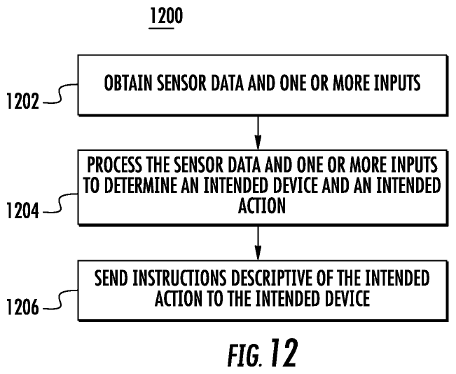

FIG. 12 depicts a flow chart diagram of an example method of controlling a remote control device according to example embodiments of the present disclosure. Although FIG. 12 depicts steps performed in a particular order for purposes of illustration and discussion, the methods of the present disclosure are not limited to the particularly illustrated order or arrangement. The various steps of the method 1200 can be omitted, rearranged, combined, and/or adapted in various ways without deviating from the scope of the present disclosure.

At 1202, a handheld remote control device can obtain sensor data and one or more inputs. The sensor data can include image data, inertial data, and/or audio data. Moreover, the inputs can include button compressions, voice commands, or gestures.

At 1204, the handheld remote control device can process the sensor data and one or more inputs to determine an intended device and an intended action. Determining the intended device can include processing the inertial data and/or image data with the spatial map and location information to determine which controllable device in the environment the handheld remote control device is pointing at or near. Determining the intended action can involve processing the one or more inputs to determine if the one or more inputs match a stored intended action for the intended device. In some implementations, the intended action may be based at least in part on an object in the environment or another controllable device in the environment.

At 1206, the handheld remote control device can send instructions descriptive of the intended action to the intended device. The instructions can be sent over a wireless network via a WiFi connection using a wireless adapter on the handheld remote control device.

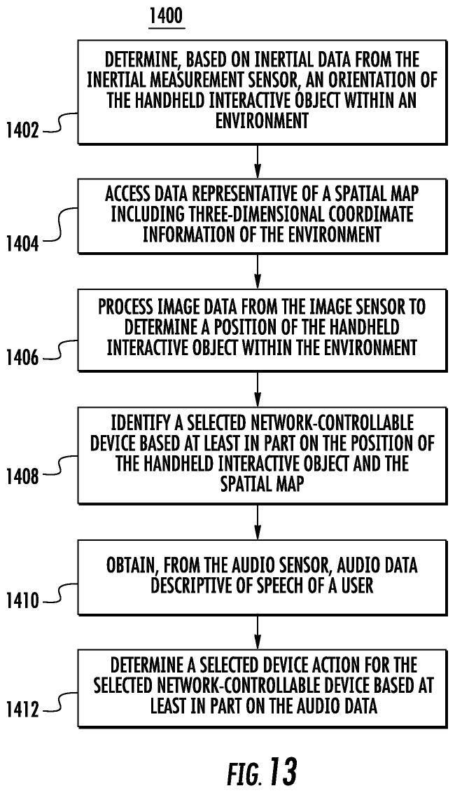

FIG. 13 depicts a flow chart diagram of an example method of processing audio data in accordance with a spatial map to process a speech command according to example embodiments of the present disclosure. Although FIG. 13 depicts steps performed in a particular order for purposes of illustration and discussion, the methods of the present disclosure are not limited to the particularly illustrated order or arrangement. The various steps of the method 1400 can be omitted, rearranged, combined, and/or adapted in various ways without deviating from the scope of the present disclosure.

At 1402, a handheld remote control device can determine, based on inertial data from the inertial measurement sensor, an orientation of the handheld interactive object within an environment. The environment can include a plurality of network-controllable devices.

At 1404, the handheld remote control device can access data representative of a spatial map including three-dimensional coordinate information of the environment. Moreover, the environment can include the plurality of network-controllable devices with respective location information stored with the spatial map.

At 1406, the handheld remote control device can process image data from the image sensor to determine a position of the handheld interactive object within the environment. The position can be determined based at least in part on the orientation of the handheld interactive object. Processing the image data can involve feature extraction, image segmentation, and/or other image processing techniques.

At 1408, the handheld remote control device can identify a selected network-controllable device based at least in part on the position of the handheld interactive object and the spatial map. Identifying a selected network-controllable device can include determining mapping the location of the handheld remote control device on the spatial map then using the orientation to determine a direction in which the handheld remote control device is pointing to determine an area being pointed to by the user. The computing system may then determine the selected network-controllable device based on a device being in the area or being closest to the area pointed to by the handheld remote control device.

At 1410, the handheld remote control device can obtain, from the audio sensor, audio data descriptive of speech of a user. Obtaining the audio sensor can further include processing sensor data to generate the audio data, which can include analog to digital conversion. Moreover, processing the sensor data may include processing the data with a natural language processing model.

At 1412, the handheld remote control device can determine a selected device action for the selected network-controllable device based at least in part on the audio data. In some implementations, the computing system can provide a notification associated with the selected device action. The notification can be a visual notification displayed on a visual display on the handheld remote control device or the controllable device. In some implementations, the notification can be an audio notification played with a speaker housed in the handheld remote control device.

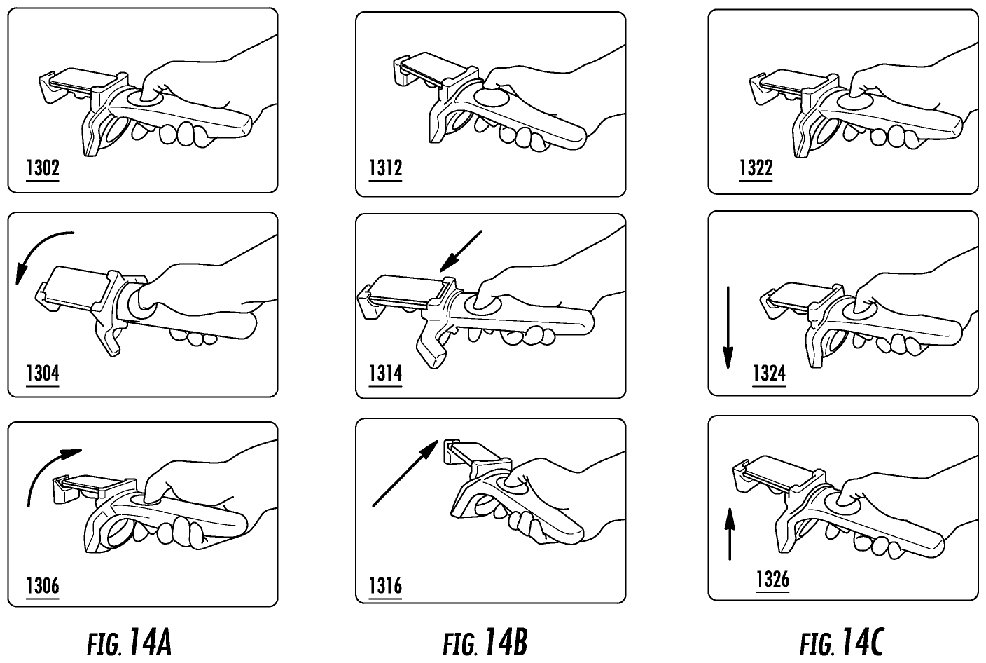

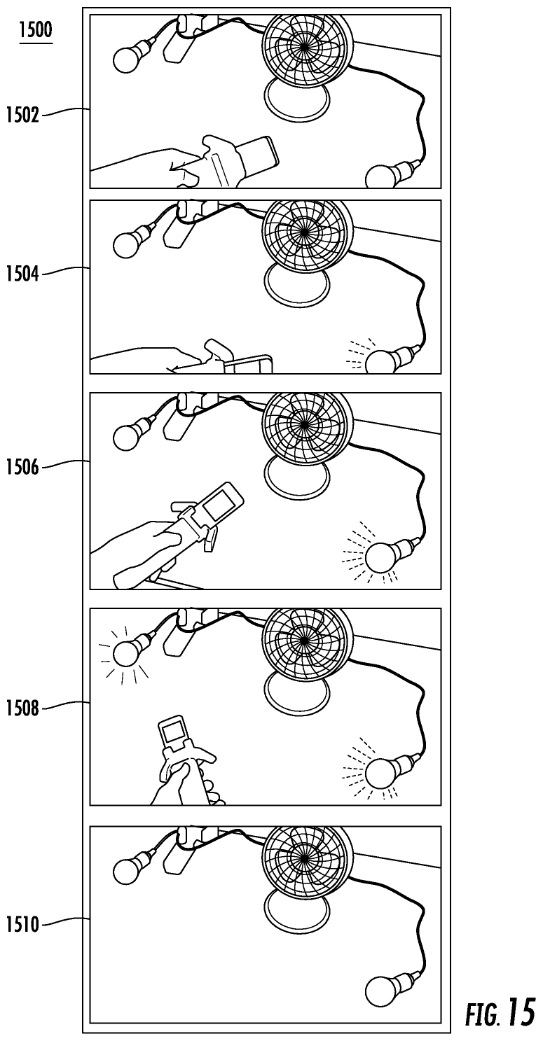

FIGS. 14A-14C depict example illustrations of example gestures according to example embodiments of the present disclosure.

FIG. 14A depicts an example dial turn gesture. The dial turn gesture can be used for a variety of different applications. For example, in response to obtaining a dial turn gesture input, the handheld remote control device may send instructions to a controllable device to raise the device volume.

A dial turn gesture can begin with an initial position 1302 and be followed by a rotation to the left 1304 or a rotation to the right. The dial turn can be followed by a return to the initial position 1302. In some implementations, the magnitude of the turn can be obtained and processed to determine the desired action. Moreover, in some implementations, a dial turn to the left 1304 followed by a dial turn to the right past the initial position 1302 can be a different gesture indicative of a different intent.

FIG. 14B depicts an example wag gesture. The wag gesture can be used for a variety of different applications. For example, in response to obtaining a wag gesture input, the handheld remote control device may send instructions to a controllable device to change the source port (e.g., a television changes from HDMI1 to HDMI2).

A wag gesture can begin with an initial position 1312 and be followed by a motion to the left 1314 then a motion to the right 1316. The wag can be followed by a return to the initial position 1312. In some implementations, the magnitude of the wag can be obtained and processed to determine the desired action. Moreover, in some implementations, a motion to the left 1314 and a motion to the right 1316 can be different gestures indicative of different intents.

FIG. 14C depicts an example down gesture. The down gesture can be used for a variety of different applications. For example, in response to obtaining a down gesture input, the handheld remote control device may send instructions to a controllable device to lower the device brightness.

A down gesture can begin with an initial position 1322 and be followed by a down motion 1324. The down motion can be followed by a return to the initial position 1326. In some implementations, the magnitude of the down motion can be obtained and processed to determine the desired action. Moreover, in some implementations, an up gesture (i.e., an up motion followed by a return to initial position) can be a different gesture indicative a different intent (e.g., the down gesture can lower the brightness of a device, while an up gesture can raise the brightness of a device).

In some implementations, the handheld remote control device can obtain motion data and determine other gestures with different intents. For example, a circular motion can be obtained and determined as a lasso gesture including two or more devices, and the handheld remote control device may process the gesture to generate a device grouping for the two or more devices.

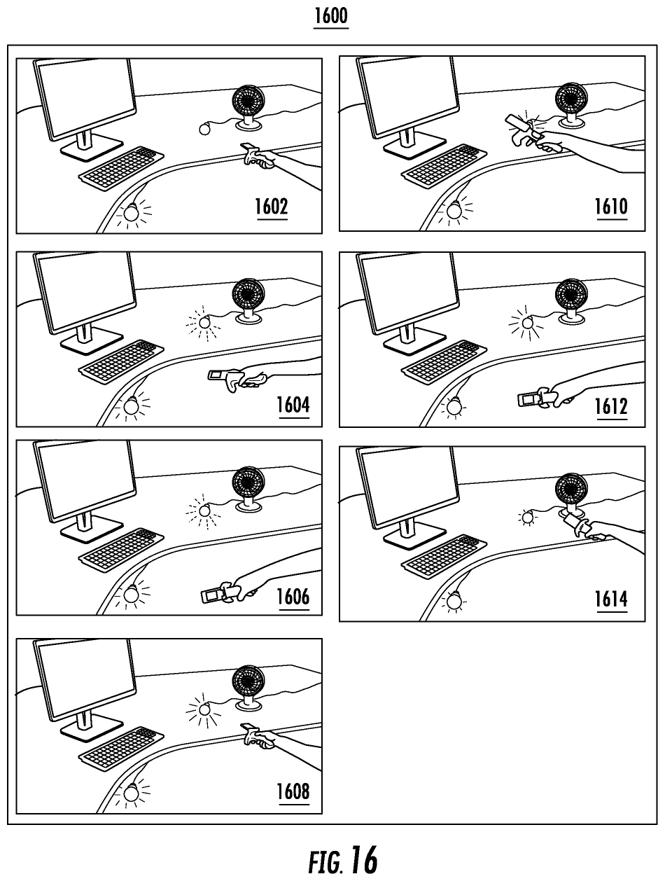

FIG. 15 depicts an illustration of an example handheld remote control device and its use in controlling a plurality of controllable devices. In example 1500, the handheld remote control device can be used to turn a plurality of devices on and off. Each of the plurality of controllable devices start in the turned off state as shown at 1502. The handheld remote control device is then pointed at each respective device to turn on the device, beginning with a first light as shown at 1504, then a fan as shown at 1506, and then a second light as shown at 1508. The handheld remote control device can be used to turn off each controllable device as shown at 1510. In some implementations, turning each device on and off may involve providing a button input, a voice command, a gesture input, or a touchscreen input.

FIG. 16 depicts an illustration of an example handheld remote control device use as shown in 1600. In example 1600, the handheld remote control device is used to drag the color of the first light bulb to the second light bulb, then the color from the computer screen is used to change the color of the second light bulb and the first light bulb. At 1602, the second light bulb is first turned on with the handheld remote control device. At 1604, the first light bulb and the second light bulb are displaying different colors. Moreover, at 1606, the user then uses the handheld remote control device to select the first light bulb by pointing at the first light bulb and inputting an input (e.g., a button compression or voice command). At 1608, the user then points at the second light bulb and provides a second input (e.g., a button decompression or voice command), which can instruct the second light fixture to change the second light bulb to the same color as the first light bulb completing the drag and drop action.

The drag and drop action can also be applied to different controllable device types (e.g., a computer monitor and a color changing light fixture). For example, at 1610, the handheld remote control device may be pointed at a computer monitor and provided with a first input. The first input may cause the handheld remote control device to obtain one or more images of the computer monitor. At 1612, the handheld remote control device may then be pointed at the first light bulb and provided with a second input. The one or more images may be processed to determine a primary color to change the first light bulb to, which can then be included with instructions sent to the first light bulb fixture. Lastly, at 1614, the process may be repeated to change the color of the second light bulb.

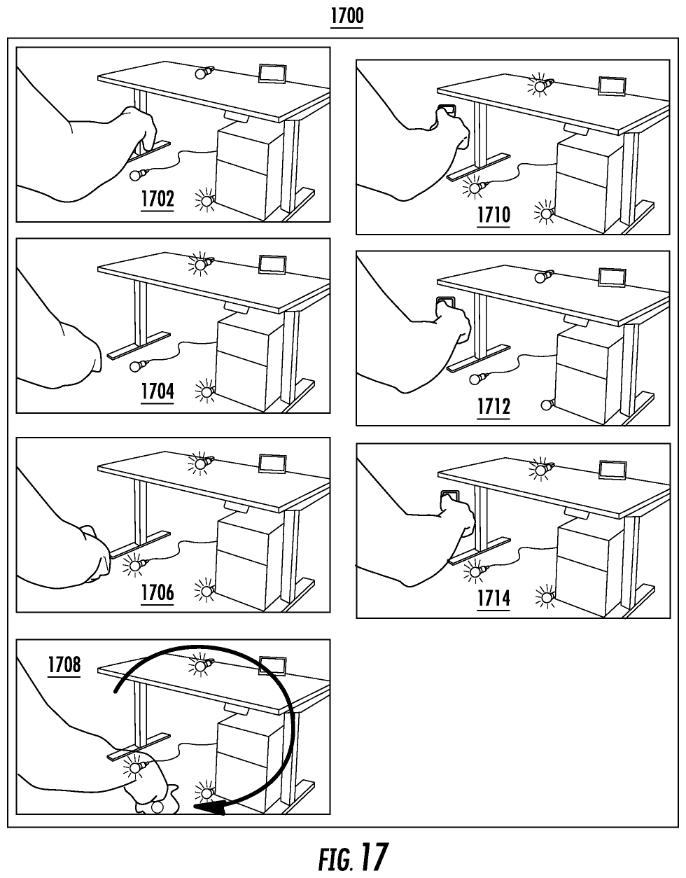

FIG. 17 depicts an illustration of an example handheld remote control device use, as shown in 1700. In example 1700, the handheld remote control device is used to group a plurality of light fixtures into a device group. Before grouping, each individual light fixture acts individually, and therefore, each light fixture is turned on in response to separate handheld remote control inputs, as shown in 1702, 1704, and 1706. However, as shown in 1708, the user may make a lasso motion engulfing the three light fixtures with the handheld remote control device to generate a device grouping with the three light fixtures. After generating the device grouping, the currently lit light fixtures, as shown in 1710, may be turned off as a group, as shown in 1712, such that when the handheld remote control device receives a singular input, the handheld remote control device may send instructions to each light fixture to turn off. At 1714, the device grouping may be manipulated together to turn the devices back on, to change color together, or complete other actions as a group.

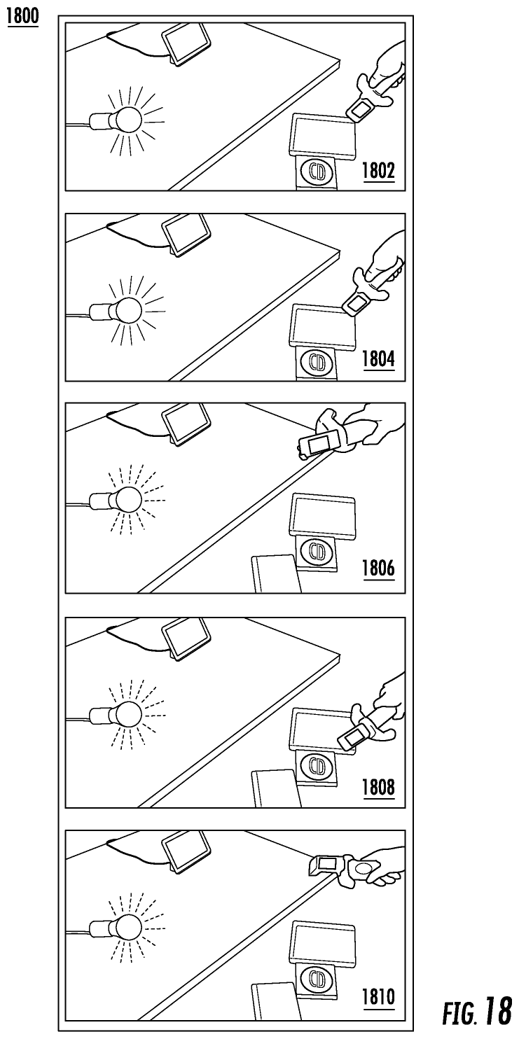

FIG. 18 depicts an illustration of an example handheld remote control device use, as shown in 1800. In example 1800, the handheld remote control device obtains a drag and drop input, processes the input, and sends instructions to a controllable device based on an object in the environment. For example, at 1802, the light bulb is a first color. As shown in 1804 and 1806, the user can then use the handheld remote control device to drag and drop the color of a book onto the light fixture to instruct the light fixture to change the light to a second color. The second color may be determined by obtaining one or more images of the object (i.e., the book), processing the images, and determining a primary color of the object.

The drag and drop input is also used to capture one or more images of a CD case to instruct the tablet to play a song off that CD, as shown in 1808 and 1810. The drag and drop input can include receiving a first input while the handheld remote control device is pointed at the CD case and a second input when the handheld remote control device is pointed at the tablet. The inputs may be compressions and decompressions of buttons or voice commands. Determining what song or album to play may involve processing the one or more images to determine the object in the images, searching for information on the object, and obtaining information on the object related to the controllable device of the second input (e.g., an audio file or a link to a media streaming service).

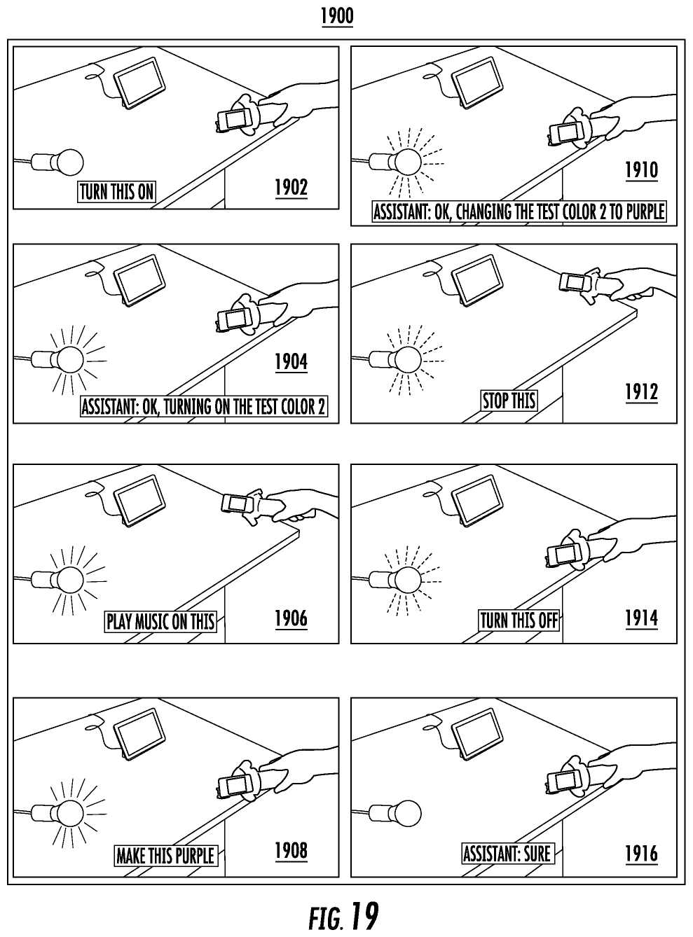

FIG. 19 depicts an illustration of an example handheld remote control device use, as shown in 1900. In example 1900, the handheld remote control device is used to control two different types of controllable devices using voice commands. The first voice command includes “turn this on” while the handheld remote control device is pointed at a light fixture, as shown in 1902. At 1904, the light fixture is then turned on, and the handheld remote control device or a connected assistant may output an audio notification indicating the light fixture was turned on. At 1906, the second voice command may include “play music on this,” while the handheld remote control device is pointed at a tablet, which can cause the tablet to play music. The user may then return to controlling the light fixture by pointing the handheld remote control device back at the light fixture, as shown in 1908, which can be followed by a third voice command to change the light color to purple. The light may change to purple, and once again, an audio notification may occur, as shown in 1910. The user may then stop the music and turn off the light bulb by providing respective voice commands for each controllable device, as shown in 1912 and 1914. At 1916, the music may then stop, and the light may turn off. In some implementations, the output audio notification may occur after each successful action, after every voice command, or after instructing particular controllable devices.

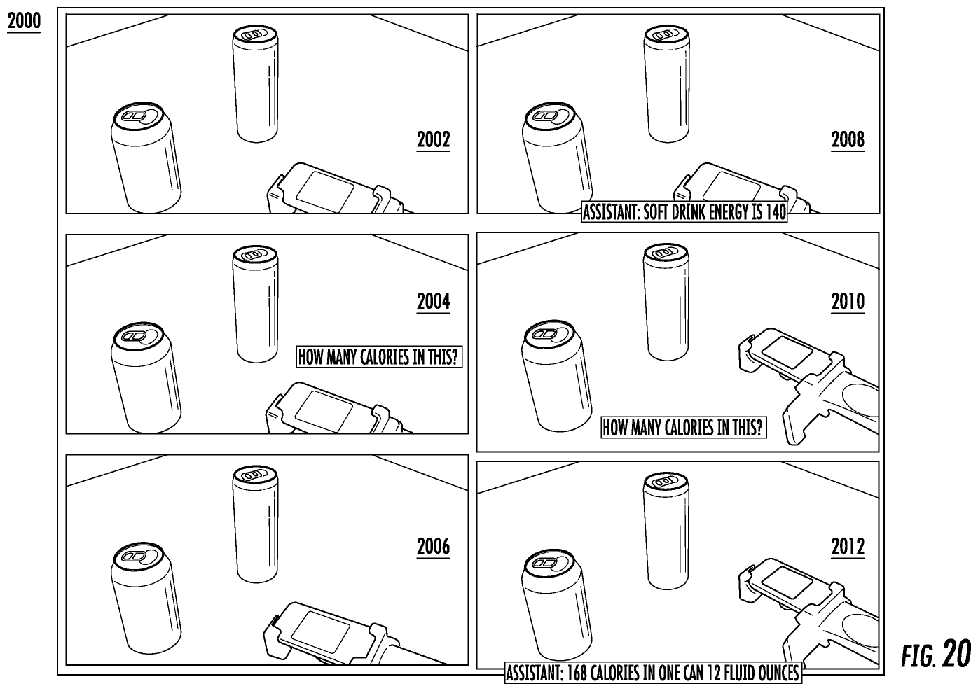

FIG. 20 depicts an illustration of an example handheld remote control device use, as shown in 2000. In example 2000, the handheld remote control device is used to generate a combination search query to obtain product information on two consumer products.

For each object, the handheld remote control device is pointed at the respective objects, as shown in 2002 and 2010. The handheld remote control device may receive a voice command, which may include a question related to the object, such as “How many calories are in this?”, as shown in 2004 and 2010. The handheld remote control device may then capture one or more images of the object, process the one or more images and the voice command to generate a query including both search terms and one or more images, and input the search query into the search engine, as shown in 2006 and 2010. The handheld remote control device may then obtain one or more search results in response to the search query. The handheld remote control device may then provide one or more search results to the user via a display or via an audio notification, as shown in 2008 and 2012. For example, the handheld remote control device may output an audio notification indicating the calorie amount from the search result with the highest ranking.

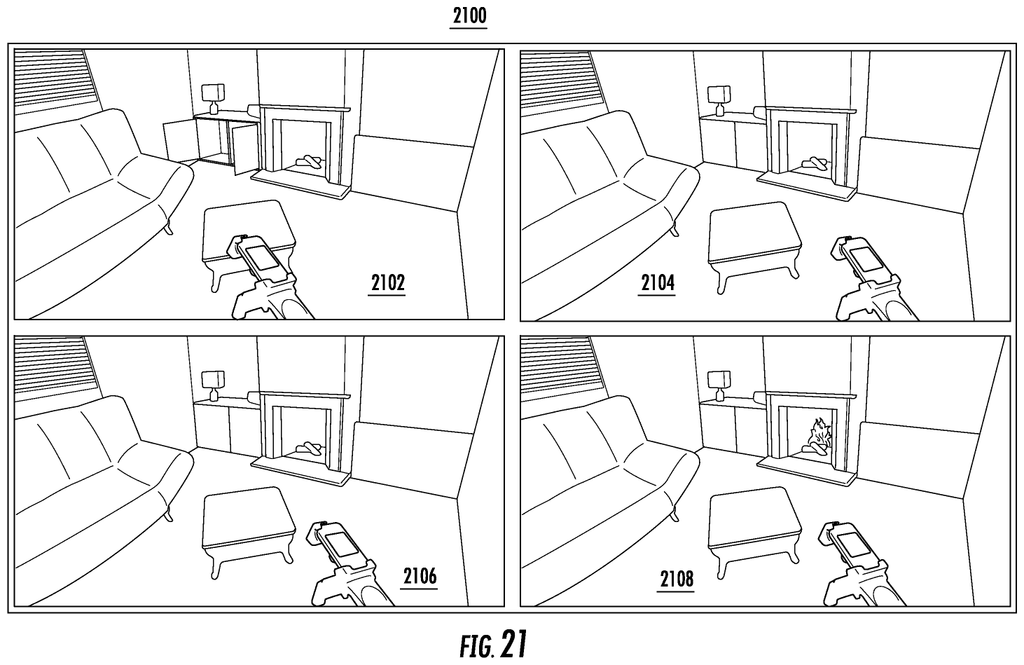

FIG. 21 depicts an illustration of an example handheld remote control device use, as shown in 2100. In example 2100, the handheld remote control device is used to manipulate a virtual reality experience. In particular, the handheld remote control device is used to open and close a rendered cabinet in the virtual reality experience, as shown in 2102 and 2104. Moreover, at 2106, the handheld remote control device is used to turn a virtual fireplace on by pointing at the virtual fireplace and at 2108, inputting an input, such as a button compression, a voice command, or a gesture. In some implementations, the handheld remote control device may be used to travel throughout the virtual reality environment, and in some implementations, the handheld remote control device may be used to create a virtual reality environment. Moreover, in some implementations, the handheld remote control device may be used as a game controller for a virtual reality game.

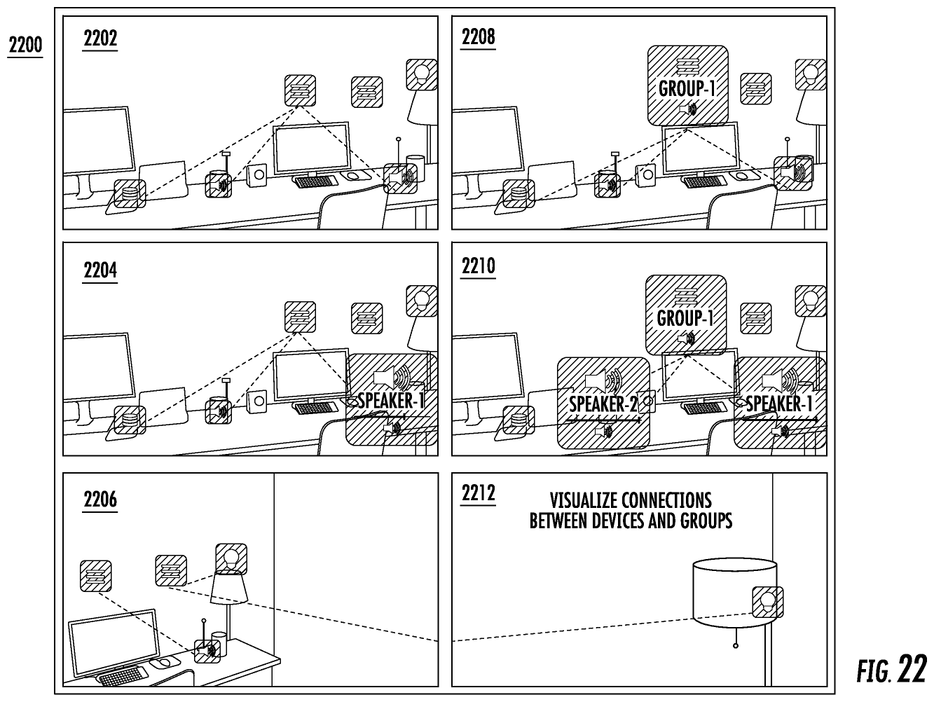

FIG. 22 depicts an illustration of an example handheld remote control device use, as shown in 2200. In example 2200, the handheld remote control device is used to control one or more controllable devices and interact with device menus using an augmented-reality experience. At 2202, a device grouping icon including a computer monitor and two speakers is displayed with respective individual icons for each controllable device in the environment including devices in the grouping and devices not in the grouping. The handheld remote control device can then be used to control the devices in the group individually, as shown in 2204, or as a group, as shown in 2210. In some implementations, the device grouping may be selected, as shown in 2208, and a secondary input may be used to control all sound devices in the grouping, as shown in 2210. Moreover, in some implementations, the augmented-reality experience may display device connections outside of user generated device groups. For example, the augmented-reality experience may display an icon for a smart outlet, as shown in 2206, and an icon for each respective lamp connected to the smart outlet, as shown in 2206 and 2212.

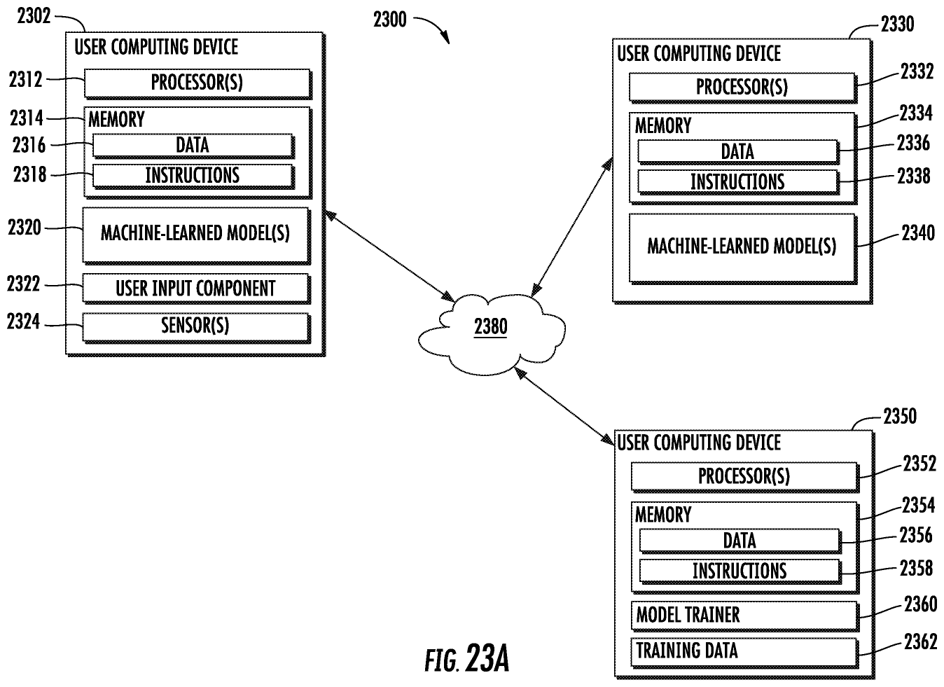

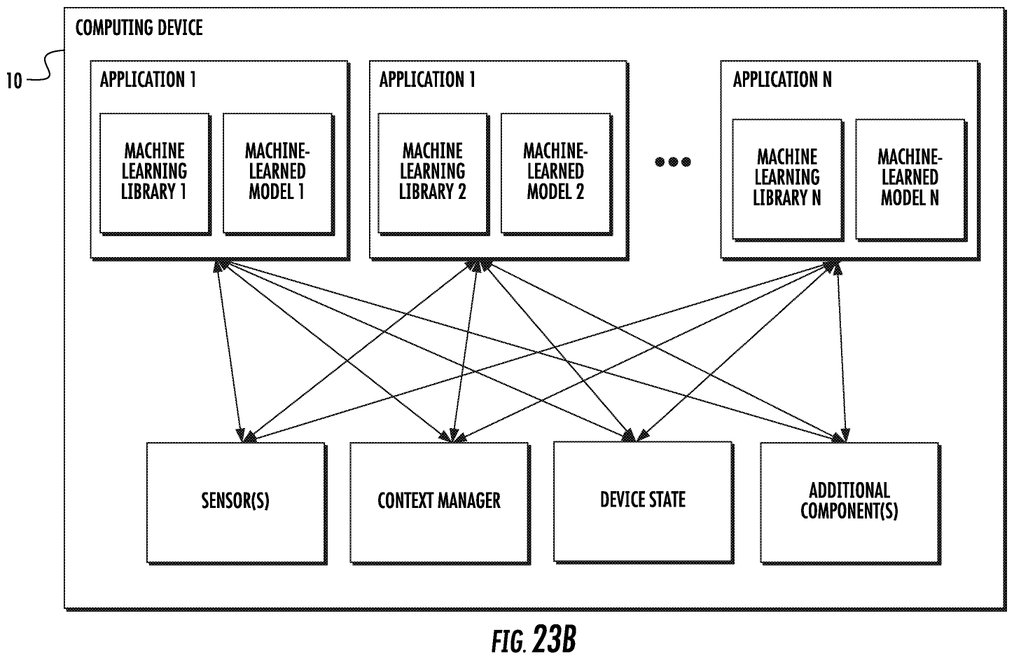

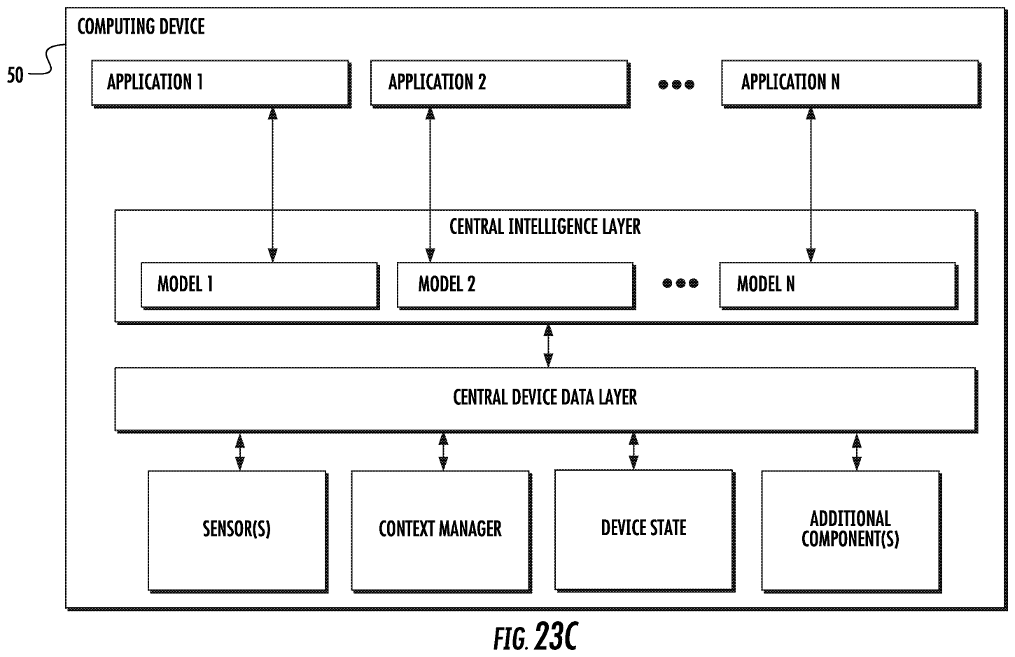

FIG. 23A depicts a block diagram of an example computing system 2300 that performs environment mapping and controllable device manipulation according to example embodiments of the present disclosure. The system 2300 includes a user computing device 2302, a server computing system 2330, and a training computing system 2350 that are communicatively coupled over a network 2380.

The user computing device 2302 can be any type of computing device, such as, for example, a handheld remote control device, a handheld interactive object, a personal computing device (e.g., laptop or desktop), a mobile computing device (e.g., smartphone or tablet), a gaming console or controller, a wearable computing device, an embedded computing device, or any other type of computing device.

The user computing device 2302 includes one or more processors 2312 and a memory 2314. The one or more processors 2312 can be any suitable processing device (e.g., a processor core, a microprocessor, an ASIC, a FPGA, a controller, a microcontroller, etc.) and can be one processor or a plurality of processors that are operatively connected. The memory 2314 can include one or more non-transitory computer-readable storage mediums, such as RAM, ROM, EEPROM, EPROM, flash memory devices, magnetic disks, etc., and combinations thereof. The memory 2314 can store data 2316 and instructions 2318 which are executed by the processor 2312 to cause the user computing device 102 to perform operations.

In some implementations, the user computing device 2302 can store or include one or more environment mapping models 2320. For example, the environment mapping models 2320 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example environment mapping models 2320 are discussed with reference to FIGS. 2, 8A, & 8B.

In some implementations, the one or more environment mapping models 2320 can be received from the server computing system 2330 over network 2380, stored in the user computing device memory 2314, and then used or otherwise implemented by the one or more processors 2312. In some implementations, the user computing device 2302 can implement multiple parallel instances of a single environment mapping model 2320 (e.g., to perform parallel environment mapping across multiple instances of controllable environments).

More particularly, a handheld remote control device can utilize a plurality of sensors to retrieve environment data to determine depth information for the environment and location information for one or more controllable devices. The environment data can be used to generate a spatial map, and the spatial map with the location information can be used to enable the handheld remote control device to control controllable devices in the environment.

Additionally or alternatively, one or more environment mapping models 2340 can be included in or otherwise stored and implemented by the server computing system 2330 that communicates with the user computing device 2302 according to a client-server relationship. For example, the environment mapping models 140 can be implemented by the server computing system 2340 as a portion of a web service. Thus, one or more models 2320 can be stored and implemented at the user computing device 2302 and/or one or more models 2340 can be stored and implemented at the server computing system 2330.

The user computing device 2302 can also include one or more user input component 2322 that receives user input. For example, the user input component 2322 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 2330 includes one or more processors 2332 and a memory 2334. The one or more processors 2332 can be any suitable processing device (e.g., a processor core, a microprocessor, an ASIC, a FPGA, a controller, a microcontroller, etc.) and can be one processor or a plurality of processors that are operatively connected. The memory 2334 can include one or more non-transitory computer-readable storage mediums, such as RAM, ROM, EEPROM, EPROM, flash memory devices, magnetic disks, etc., and combinations thereof. The memory 2334 can store data 2336 and instructions 2338 which are executed by the processor 2332 to cause the server computing system 2330 to perform operations.

In some implementations, the server computing system 2330 includes or is otherwise implemented by one or more server computing devices. In instances in which the server computing system 2330 includes plural server computing devices, such server computing devices can operate according to sequential computing architectures, parallel computing architectures, or some combination thereof.

As described above, the server computing system 2330 can store or otherwise include one or more machine-learned environment mapping models 2340. For example, the models 2340 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 2340 are discussed with reference to FIGS. 2, 8A, & 8B.

The user computing device 2302 and/or the server computing system 2330 can train the models 2320 and/or 2340 via interaction with the training computing system 2350 that is communicatively coupled over the network 2380. The training computing system 2350 can be separate from the server computing system 2330 or can be a portion of the server computing system 2330.

The training computing system 2350 includes one or more processors 2352 and a memory 2354. The one or more processors 2352 can be any suitable processing device (e.g., a processor core, a microprocessor, an ASIC, a FPGA, a controller, a microcontroller, etc.) and can be one processor or a plurality of processors that are operatively connected. The memory 2354 can include one or more non-transitory computer-readable storage mediums, such as RAM, ROM, EEPROM, EPROM, flash memory devices, magnetic disks, etc., and combinations thereof. The memory 2354 can store data 2356 and instructions 2358 which are executed by the processor 2352 to cause the training computing system 2350 to perform operations. In some implementations, the training computing system 2350 includes or is otherwise implemented by one or more server computing devices.

The training computing system 2350 can include a model trainer 2360 that trains the machine-learned models 2320 and/or 2340 stored at the user computing device 2302 and/or the server computing system 2330 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 2360 can perform a number of generalization techniques (e.g., weight decays, dropouts, etc.) to improve the generalization capability of the models being trained.

In particular, the model trainer 2360 can train the environment mapping models 2320 and/or 2340 based on a set of training data 2362. The training data 2362 can include, for example, a plurality of images with a ground truth set of depth information and a ground truth spatial map. In some implementations, the training data 2362 can further include inertial data and ground truth location information.

In some implementations, if the user has provided consent, the training examples can be provided by the user computing device 2302. Thus, in such implementations, the model 2320 provided to the user computing device 2302 can be trained by the training computing system 2350 on user-specific data received from the user computing device 2302. In some instances, this process can be referred to as personalizing the model.

The model trainer 2360 includes computer logic utilized to provide desired functionality. The model trainer 2360 can be implemented in hardware, firmware, and/or software controlling a general purpose processor. For example, in some implementations, the model trainer 2360 includes program files stored on a storage device, loaded into a memory and executed by one or more processors. In other implementations, the model trainer 2360 includes one or more sets of computer-executable instructions that are stored in a tangible computer-readable storage medium such as RAM hard disk or optical or magnetic media.

The network 2380 can be any type of communications network, such as a local area network (e.g., intranet), wide area network (e.g., Internet), or some combination thereof and can include any number of wired or wireless links. In general, communication over the network 2380 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 23A illustrates one example computing system that can be used to implement the present disclosure. Other computing systems can be used as well. For example, in some implementations, the user computing device 2302 can include the model trainer 2360 and the training dataset 2362. In such implementations, the models 2320 can be both trained and used locally at the user computing device 2302. In some of such implementations, the user computing device 2302 can implement the model trainer 2360 to personalize the models 2320 based on user-specific data.

FIG. 23B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 23B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 23C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 23C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 23C, the central device data layer can communicate with a number of other components of the computing device, such as, for example, one or more sensors, a context manager, a device state component, and/or additional components. In some implementations, the central device data layer can communicate with each device component using an API (e.g., a private API).

Alternatively and/or additionally, the systems and methods may utilize a computing system with a different architecture that may include or may not include one or more machine-learned models. For example, in some implementations, the handheld remote control device, or handheld interactive object, may not include a locally stored machine-learned model but may instead be updated in intervals via communication with a server computing system, when an update is available.

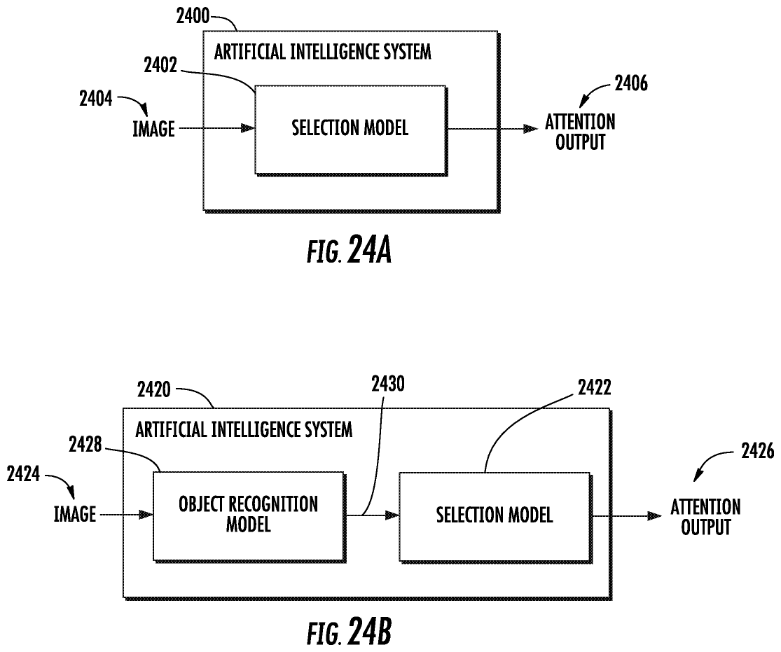

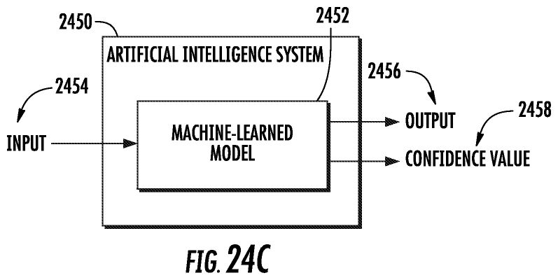

FIG. 24A depicts a block diagram of an example artificial intelligence system 2400 according to example embodiments of the present disclosure. In some implementations, the computing system may be configured to control a plurality of sensors of the artificial intelligence system 2400 in an environment.

More specifically, the artificial intelligence system 2400 may be configured to select, categorize, analyze, or otherwise perform a processing operation with respect to an image 2404 of a scene. For example, the artificial intelligence system 2400 may include a selection model 2402 that is trained to receive an image 2404 of a scene and, in response, provide an attention output 2406 that describes at least one region of the scene that includes a subject of the processing operation performed by the artificial intelligence system 2400.

FIG. 24B depicts a block diagram of another example artificial intelligence system 2420 according to example embodiments of the present disclosure. The artificial intelligence system 2420 is similar to the artificial intelligence system 2400 of FIG. 24A except that the artificial intelligence system 2420 further includes an object recognition model 2428. The object recognition model 2428 may be configured to receive an image 2424 of a scene and, in response, provide a recognition output 2430 that describes a region of the image 2424. For example, the recognition output 2430 may describe a category, a label, a characteristic, and/or a location within the image 2424 associated with the image 2424. The selection model may be configured to receive the recognition output 2430 and, in response, provide an attention output 2426 that describes at least one region of the scene that includes a subject of the processing operation performed by the artificial intelligence system 2400. For example, the attention output 2426 can describe the object or device of a region of the image 2424 in response to a question or command from the user. Alternatively, the attention output 2426 can describe a region of the image 2424 that the selection model 2422 has determined as important, relevant, or responsive to a question/command posed by the user or an anticipated desire of the user.

FIG. 24C depicts a block diagram of another example artificial intelligence system 2450 according to example embodiments of the present disclosure. The artificial intelligence system 2450 may include a machine-learned model 2452 that is configured to receive an input 2454, and in response to receiving the input 2454 generate an output 2456 and a confidence value 2458 associated with the output 2456. The machine-learned model 2452 may be any suitable type of model. Similarly, the input 2454 and output 2456 may be any type of information associated with the functions of the computing device, including “personal assistant” functions, for example.

The confidence value 2458 may describe a confidence level associated with the output 2456 generated by the machine-learned model 2452. As an example, the confidence value 2458 may describe a degree of convergence on a solution to a question posed by the user. As another example, the output 2456 may be selected from a set of candidate solutions, and the confidence value 2458 may describe a relative confidence (e.g., a probability, a weight, etc.) associated with the output 2456 as compared with the remainder of the set of candidate solutions.

In some implementations, the computing system may display a confidence graphic that graphically describes the confidence value associated with the output of the machine-learned model. As examples, the confidence graphic may include at least one of a shape density, a color combination, or a shape movement characteristic that describes the confidence value output by the machine-learned model.

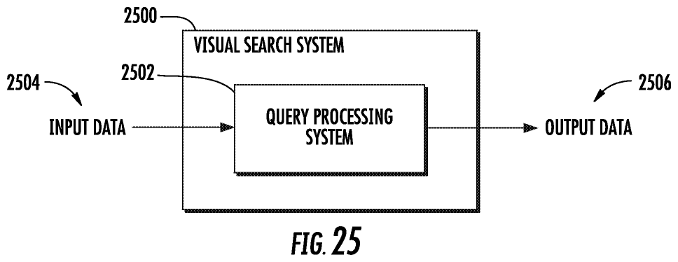

FIG. 25 depicts a block diagram of an example visual search system 2500 according to example embodiments of the present disclosure. In some implementations, the visual search system 2500 is configured to receive a set of input data that includes visual queries 2504 and, as a result of receipt of the input data 2504, provide output data 2506 that provides the user with more personalized and/or intelligent results. As an example, in some implementations, the visual search system 2500 can include a query processing system 2502 that is operable to facilitate the output of more personalized and/or intelligent visual query results.

In some implementations, the query processing system 2502 includes or leverages a user-centric visual interest graph to provide more personalized search results. In one example use, the visual search system 2500 can use the graph of user interests to rank or filter search results, including visual discovery alerts, notifications, or other opportunities. Personalization of search results based on user interests may be particularly advantageous in example embodiments in which the search results are presented as visual result notifications (e.g., which may in some instances be referred to as “gleams”) in an augmented overlay upon the query image(s).

In some implementations, the user-specific interest data (e.g., which may be represented using a graph) can be aggregated over time at least in part by analyzing images that the user has engaged with in the past. Stated differently, the visual search system 2500 can attempt to understand a user's visual interests by analyzing images with which the user engages over time. When a user engages with an image, it can be inferred that some aspect of the image is interesting to the user. Therefore, items (e.g., objects, entities, concepts, products, etc.). that are included within or otherwise related to such images can be added or otherwise noted within the user-specific interest data (e.g., graph).

As one example, images that a user engages with can include user-captured photographs, user-captured screenshots, or images included in web-based or application-based content viewed by the user. In another, potentially overlapping example, images that a user engages with can include actively engaged images with which the user has actively engaged by requesting an action to be performed on the image. For example, the requested action can include performing a visual search relative to the image or explicitly marking by the user that the image includes a visual interest of the user. As another example, images that a user engages with can include passively observed images that were presented to the user but not specifically engaged with by the user. Visual interests can also be inferred from textual content entered by the user (e.g., text- or term-based queries).

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The visual search system 2500 can use the query processing system 2502 to select search results for the user. The user interest system 2502 can be used at various stages of the search process including query modification, result identification, and/or other stages of a visual search process.

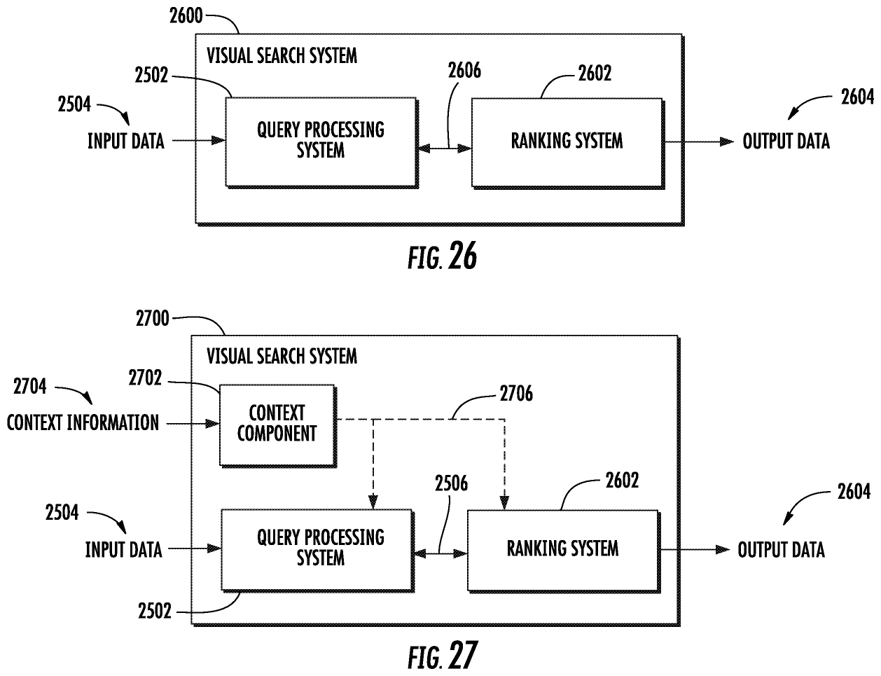

As one example, FIG. 26 depicts a block diagram of an example visual search system 2600 according to example embodiments of the present disclosure. The visual search system 2600 operates in a two-stage process. In a first stage, a query processing system 2502 can receive the input data 2504 (e.g., a visual query that includes one or more images) and generate a set of candidate search results 2506 that are responsive to the visual query. For example, the candidate search results 2506 can be obtained without regard for user-specific interests. In a second stage, the ranking system 2602 can be used by the visual search system 2600 to assist in ranking the one or more of the candidate search results 2506 to return to the user as final search results (e.g., as the output data 2604).

As one example, the visual search system 2600 can use the ranking system 2602 to generate a ranking of the plurality of candidate search results 2506 based at least in part on a comparison of the plurality of candidate search results 2506 to the user-specific user interest data associated with the user obtained in the query processing system 2502. For example, the weights for certain items captured within the user interest data can be applied to modify or re-weight initial search scores associated with the candidate search results 2506 which could further lead to a re-ranking of the search results 2506 prior to output to the user 2604.

The visual search system 2600 can select at least one of the plurality of candidate search results 2506 as at least one selected search result based at least in part on the ranking and then provide at least one selected visual result notification respectively associated with the at least one selected search result for display to the user (e.g., as output data 2604). In one example, each of the selected search result(s) can be provided for overlay upon a particular sub-portion of the image associated with the selected search result. In such fashion, user interests can be used to provide personalized search results and reduce clutter in a user interface.

As another example variant, FIG. 27 depicts a block diagram of an example visual search system 2700 according to example embodiments of the present disclosure. The visual search system 2700 is similar to visual search system 2600 of FIG. 26 except that the visual search system 2700 further includes a context component 2702 which receives context information 2704 and processes the context information 2704 to account for implicit characteristics of the visual query and/or user's search intent.

The contextual information 2704 can include any other available signals or information that assist in understanding implicit characteristics of the query. For example, location, time of day, input modality, and/or various other information can be used as context.

As another example, the contextual information 2704 can include various attributes of the image, information about where the image was sourced by the user, information about other uses or instances of the image, and/or various other contextual information. In one example, the image used in the visual search query is present in a web document (e.g., a web page). References to other entities (e.g., textual and/or visual references) included in the web document can be used to identify potential additional entities which may be used to form the composition of multiple entities.

In another example, the contextual information 2704 can include information obtained from additional web documents that include additional instances of the image associated with the visual search query. As another example, the contextual information 2704 can include textual metadata associated with the image (e.g., EXIF data). In particular, textual metadata may be accessed and may be identified as the additional entities associated with the visual search. Specifically, textual metadata may include captions to the image used in the visual query submitted by the user.

As another example, the contextual information 2704 can include information obtained via a preliminary search based on the visual query. More specifically, a first search may be made using information from the visual query and, upon obtaining a first set of preliminary search results, further entities may be identified which are referenced by the preliminary search results. In particular, entities that are identified in some number of preliminary results exceeding a threshold may be determined to be pertinent enough to be included in a following query.

Referring to any of the visual search systems 2500, 2600 and/or 2700 of FIGS. 25, 26, and 27, a computing system can implement an edge detection algorithm to process the objects depicted in the images provided as the visual query input data 2504. Specifically, the image acquired may be filtered with an edge detection algorithm (e.g., gradient filter), thereby obtaining a resulting image, which represent a binary matrix which may be measured in a horizontal and vertical direction determining position of objects contained in the image within the matrix. Additionally, the resulting image may further be advantageously filtered using a Laplacian and/or Gaussian Filter for improved detection of edges. Objects may then be compared against a plurality of training images and/or historical images of any kind and/or context information 2704 with Boolean operators, such as “AND” and “OR” Boolean operators. Utilizing Boolean comparisons provides for very fast and efficient comparisons which is preferable however in certain circumstances non-Boolean operators may be desired.

Furthermore, a similarity algorithm may be accessed by the visual search system 2500, 2600 and/or 2700 of FIGS. 25, 26, and/or 27 where the algorithm may access the edge detection algorithm described above and store the output data. Additionally, and/or alternatively the similarity algorithm can estimate a pairwise similarity function between each image and/or query input data 2504 and a plurality of other images and/or queries and/or context information 2704 that may be training data and/or historical data of any kind. The pairwise similarity function can describe whether two data points are similar or not.

Additionally, or alternatively, the visual search system 2500, 2600 and/or 2700 of FIGS. 25, 26, and/or 27 can implement a clustering algorithm to process the images provided as a visual query input data 2504. The search system may execute the clustering algorithm and assign images and/or queries to the clusters based upon the estimated pairwise similarity functions. The number of clusters can be an unknown prior to executing the clustering algorithm and can vary from one execution of the clustering algorithm to the next based on the images/visual query input data 2504, the estimated pairwise similarity function for each pair of image/queries, and random or pseudo-random selection of an initial image/query assigned to each cluster.

The visual search system 2500, 2600 and/or 2700 can execute the clustering algorithm once or multiple times on the set of image/query input data 2504. In certain exemplary embodiments, the visual search system 2500, 2600 and/or 2700 can execute the clustering algorithm a predetermined number of iterations. In certain exemplary embodiments, the visual search system 2500, 2600 and/or 2700 can execute the clustering algorithm and aggregate the results until a measure of distance from the pairwise similarity function being nontransitive is reached.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A handheld remote control device comprising:
a plurality of sensors including one or more inertial sensors, one or more audio sensors, and one or more additional sensors;
one or more processors; and
one or more non-transitory computer-readable media that collectively store instructions that, when executed by the one or more processors, cause the handheld remote control device to perform operations, the operations comprising:
generating, by at least one of the one or more additional sensors of the handheld remote control device, sensor data descriptive of an environment including a plurality of controllable computing devices;
generating data representative of a spatial map of the environment based at least in part on the sensor data descriptive of the environment;
receiving one or more inputs from a user of the handheld remote control device in association with each of the plurality of controllable computing devices;
generating, by the one or more inertial sensors, inertial data indicative of an orientation of the handheld remote control device;
in response to the one or more inputs associated with each controllable computing device of the plurality of controllable computing devices, identifying a location of such controllable computing device based at least in part on the spatial map and the inertial data associated with one or more time periods associated with the one or more inputs;
generating location information for the spatial map indicating the location within the environment of each controllable computing device of the plurality of controllable computing devices; and
storing the data representative of the spatial map and the location information locally by the handheld remote control device;
receiving first audio data with the one or more audio sensors at a first time when the user is pointing the handheld remote control device toward a first controllable computing device of the plurality of controllable computing devices, the first audio data comprising first speech data from the user;
processing the first audio data to determine a first command applicable to said first controllable computing device of the plurality of controllable computing devices, and causing the first command to be carried out by said first controllable computing device of the plurality of controllable computing devices;
receiving second audio data with the audio sensor at a second time when the user is pointing the handheld remote control device toward an object that is not one of the controllable computing devices, the second audio data comprising second speech data from the user;
processing the second audio data to determine a second command, wherein the second command comprises a context-based voice-triggered search function;
processing image data from the one or more image sensors to determine one or more semantic attributes associated with the object;
generating one or more textual search queries based on the context-based voice-triggered search function and the one or more semantic attributes associated with the object; and
generating one or more outputs at the handheld remote control device based on search results received in response to the one or more textual search queries.

2. The handheld remote control device of claim 1, wherein:
the one or more additional sensors comprise one or more image sensors;
the sensor data comprises image data;
the operations further comprise processing the image data to determine depth information descriptive of the environment; and
generating the data representative of the spatial map of the environment comprises generating the data representative of the spatial map of the environment based at least in part on the depth information.

3. The handheld remote control device of claim 2, wherein:
generating the data representative of the spatial map of the environment comprises image recognition processing.

4. The handheld remote control device of claim 1, wherein the operations further comprise:
generating, by the one or more audio sensors, audio data descriptive of speech of the user;
processing the audio data and the inertial data to generate a label for one of the plurality of controllable computing devices; and
storing the label as part of the spatial map locally on the handheld remote control device.

5. The handheld remote control device of claim 1, wherein the operations further comprise:
receiving, by the handheld remote control device, a first additional input from a user of the handheld remote control device;
identifying a first selected device based on the spatial map and sensor data generated by at least one of the plurality of sensors in association with the first additional input;
generating a first device data set based on sensor data generated by at least one of the plurality of sensors in association with the first selected device;
receiving, by the handheld remote control device, a second additional input from a user of the handheld remote control device;
identifying a second selected device based on the spatial map and sensor data generated by at least one of the plurality of sensors in association with the second additional input;
determining, by the one or more processors, a device action based on the first device data set and the second selected device; and
transmitting instructions indicative of the device action to the second selected device.

6. The handheld remote control device of claim 5, wherein the operations further comprise:
generating, by the one or more image sensors, image data descriptive of content rendered by the first selected device; and
processing the image data to determine one or more colors associated with the content rendered by the first selected device;
wherein the device action comprises illuminating at least one light source of the second selected device based at least in part on the one or more colors associated with the content rendered by the first selected device.

7. The handheld remote control device of claim 5, wherein:
the first device data set comprises content of a first media type;
determining the device action based on the first device data set and the second selected device comprises:
determining one or more device parameters indicative of a second media type supported by the second selected device; and
obtaining content of the second media type based on the content of the first media type from the first selected device; and
the device action comprises providing the content of the second media type as at least one output of the second selected device.

8. The handheld remote control device of claim 1, wherein:
the one or more additional sensors include an ultra-wideband wireless transceiver;
the sensor data comprises position information associated with the ultra-wideband wireless transceiver; and
generating the spatial map of the environment is based at least in part on the position information associated with the ultra-wideband wireless transceiver.

9. The handheld remote control device of claim 1, wherein the spatial map comprises three-dimensional point cloud data.

10. The handheld remote control device of claim 1, further comprising:
an electronic display;
one or more first user input devices proximate a first side of the handheld remote control device; and
one or more second user input devices proximate a second side of the handheld remote control device.

11. The handheld remote control device of claim 1, wherein the operations further comprise:
providing the one or more textual search queries to a search engine; and
obtaining the search results from the search engine in response to the one or more textual search queries.

12. The handheld remote control device of claim 1, wherein:
the image data comprises one or more images of a consumer product; and
the search results comprise information associated with the consumer product.

13. A computer-implemented method for device grouping, the method comprising:
generating, by an inertial measurement sensor of a remote control device, movement data indicative of movement of the remote control device;
generating, by one or more image sensors of the remote control device, image data descriptive of an environment including a plurality of controllable devices;
detecting, by one or more processors of the remote control device and based at least in part on the movement data, that a user of the remote control device has performed a grouping gesture;
accessing, by the one or more processors, data representative of a spatial map including three-dimensional coordinate information of the environment including location information for the plurality of controllable devices;
identifying, by the one or more processors, at least a first controllable device and a second controllable device associated with the grouping gesture based at least in part on the movement data, the image data, and the spatial map;
generating, by the one or more processors, a device grouping for the first controllable device and the second controllable device; and
storing, by the one or more processors, the device grouping locally on the remote control device.

14. The method of claim 13, further comprising:
receiving, by the remote control device, a user input;
identifying, by the one or more processors, the device grouping in response to the user input based at least in part on the spatial map, image data associated with one or more time periods associated with the user input, and movement data associated with the one or more time periods associated with the user input;
determine, by the one or more processors, an intended action for the device grouping based on the user input; and
sending, by the one or more processors, instructions to the device grouping to complete the intended action.

15. The method of claim 14, wherein:
the intended action comprises controlling all devices in the device grouping; and
the instructions comprise a command to control the first controllable device and the second controllable device.

16. The method of claim 13, further comprising:
obtaining, by the remote control device, one or more first user inputs;
generating, by the inertial measurement sensor, a second set of movement data indicative of movement of the remote control device;
determining, by the one or more processors, that the one or more first user inputs are directed at the device grouping based on the second set of movement data and the spatial map;
receiving, by the remote control device, a second user input;
identifying, by the one or more processors, the device grouping in response to the second user input based at least in part on the spatial map, image data associated with one or more time periods associated with the second user input, and movement data associated with the one or more time periods associated with the second user input; and
in response to identifying the device grouping in response to the second user input, providing, by a display of the remote control device, display options comprising a control device group option or a control individual devices option.

17. The method of claim 13, wherein:
a third controllable device is associated with the grouping gesture; and
the device grouping comprises data indicative of the first controllable device, the second controllable device, and the third controllable device.

18. The method of claim 13, wherein the first controllable device comprises a light fixture.

19. The method of claim 13, wherein the grouping gesture comprises a lasso gesture encompassing the first controllable device and the second controllable device.

20. An interactive object comprising:
a plurality of sensors comprising an audio sensor, an image sensor, and an inertial measurement sensor;
one or more processors; and
one or more non-transitory computer-readable media that collectively store instructions that, when executed by the one or more processors, cause the interactive object to perform operations, the operations comprising:
determining, based on inertial data from the inertial measurement sensor, an orientation of the interactive object within an environment including a plurality of network-controllable devices;
accessing data representative of a spatial map including three-dimensional coordinate information of the environment including the plurality of network-controllable devices;
processing image data from the image sensor to determine a position of the interactive object within the environment based at least in part on the orientation of the interactive object;
identifying a selected network-controllable device based at least in part on the position of the interactive object and the spatial map;
obtaining, from the audio sensor, audio data descriptive of speech of a user; and
determining a selected device action for the selected network-controllable device based at least in part on the audio data.

21. The interactive object of claim 20, further comprising:
a visual display; and
wherein the operations further comprise providing a visual notification associated with the selected device action for display on the visual display.

22. The interactive object of claim 20, further comprising:
a speaker;
wherein the operations further comprise providing an audio notification associated with the selected device action via the speaker.

23. The interactive object of claim 20, wherein:
the one or more non-transitory computer-readable media store a natural language processing model; and
processing the audio data to determine a function comprises natural language processing using the natural language processing model.

24. The interactive object of claim 20, further comprising one or more haptic actuators configured to provide haptic feedback.

25. The interactive object of claim 24, wherein the operations further comprise:
identifying one or more network-controllable devices within a controllable space of the interactive object based at least in part on the image data and the orientation of the interactive object; and
providing haptic feedback indicative of a position of the one or more network-controllable devices in response to the identifying the one or more network-controllable devices within the controllable space.

26. A handheld remote control device comprising:
a plurality of sensors including one or more inertial sensors and one or more additional sensors;
one or more processors; and
one or more non-transitory computer-readable media that collectively store instructions that, when executed by the one or more processors, cause the handheld remote control device to perform operations, the operations comprising:
generating, by at least one of the one or more additional sensors of the handheld remote control device, sensor data descriptive of an environment including a plurality of controllable computing devices;
generating data representative of a spatial map of the environment based at least in part on the sensor data descriptive of the environment;
receiving one or more inputs from a user of the handheld remote control device in association with each of the plurality of controllable computing devices;
generating, by the one or more inertial sensors, inertial data indicative of an orientation of the handheld remote control device;
in response to the one or more inputs associated with each controllable computing device of the plurality of controllable computing devices, identifying a location of such controllable computing device based at least in part on the spatial map and the inertial data associated with one or more time periods associated with the one or more inputs;
generating location information for the spatial map indicating the location within the environment of each controllable computing device of the plurality of controllable computing devices; and
storing the data representative of the spatial map and the location information locally by the handheld remote control device.

27. The handheld remote control device of claim 26, wherein:
the one or more additional sensors comprise one or more image sensors;
the sensor data comprises image data;
the operations further comprise processing the image data to determine depth information descriptive of the environment; and
generating the data representative of the spatial map of the environment comprises generating the data representative of the spatial map of the environment based at least in part on the depth information.

28. The handheld remote control device of claim 27, wherein:
generating the data representative of the spatial map of the environment comprises image recognition processing.

29. The handheld remote control device of claim 26, wherein the plurality of sensors comprise an audio sensor and the operations comprise:
generating, by the audio sensor, audio data descriptive of speech of the user;
processing the audio data and the inertial data to generate a label for one of the plurality of controllable computing devices; and
storing the label as part of the spatial map locally on the handheld remote control device.

30. The handheld remote control device of claim 26, wherein the operations further comprise:
receiving, by the handheld remote control device, a first additional input from a user of the handheld remote control device;
identifying a first selected device based on the spatial map and sensor data generated by at least one of the plurality of sensors in association with the first additional input;
generating a first device data set based on sensor data generated by at least one of the plurality of sensors in association with the first selected device;
receiving, by the handheld remote control device, a second additional input from a user of the handheld remote control device;
identifying a second selected device based on the spatial map and sensor data generated by at least one of the plurality of sensors in association with the second additional input;
determining, by the one or more processors, a device action based on the first device data set and the second selected device; and
transmitting instructions indicative of the device action to the second selected device.

31. The handheld remote control device of claim 30, wherein the operations further comprise:
generating, by the one or more image sensors, image data descriptive of content rendered by the first selected device; and
processing the image data to determine one or more colors associated with the content rendered by the first selected device;
wherein the device action comprises illuminating at least one light source of the second selected device based at least in part on the one or more colors associated with the content rendered by the first selected device.

32. The handheld remote control device of claim 30, wherein:
the first device data set comprises content of a first media type;
determining the device action based on the first device data set and the second selected device comprises:
determining one or more device parameters indicative of a second media type supported by the second selected device; and
obtaining content of the second media type based on the content of the first media type from the first selected device; and
the device action comprises providing the content of the second media type as at least one output of the second selected device.

33. The handheld remote control device of claim 26, wherein:
the one or more additional sensors include an ultra-wideband wireless transceiver;
the sensor data comprises position information associated with the ultra-wideband wireless transceiver; and
generating the spatial map of the environment is based at least in part on the position information associated with the ultra-wideband wireless transceiver.

34. The handheld remote control device of claim 26, wherein the spatial map comprises three-dimensional point cloud data.

35. The handheld remote control device of claim 26, further comprising:
an electronic display;
one or more first user input devices proximate a first side of the handheld remote control device; and
one or more second user input devices proximate a second side of the handheld remote control device.

36. The handheld remote control device of claim 26, further comprising:
an audio sensor; and
wherein the operations further comprise:
generating audio data with the audio sensor, wherein the audio data comprises speech data descriptive of speech of a user;
processing the audio data to determine a command, wherein the command comprises a context-based voice-triggered search function;
processing image data from the one or more image sensors to determine one or more semantic attributes associated with an object;
generating one or more textual search queries based on the context-based voice-triggered search function and the one or more semantic attributes associated with the object; and
generating one or more outputs at the handheld remote control device based on search results received in response to the one or more textual search queries.

37. The handheld remote control device of claim 36, wherein the operations further comprise:
providing the one or more textual search queries to a search engine; and
obtaining the search results from the search engine in response to the one or more textual search queries.

38. The handheld remote control device of claim 36, wherein:
the image data comprises one or more images of a consumer product; and
the search results comprise information associated with the consumer product.
